(19) United States
(12) Patent Application Publication
(10) Pub. No.: US 2019/0235672 A1
(43) Pub. Date: Aug. 1, 2019

(54) CONDUCTIVE SHEET FOR TOUCH SENSOR, METHOD FOR MANUFACTURING CONDUCTIVE SHEET FOR TOUCH SENSOR, TOUCH SENSOR, TOUCH PANEL LAMINATE, TOUCH PANEL, AND COMPOSITION FOR FORMING TRANSPARENT INSULATION LAYER

(71) Applicant: FUJIFILM Corporation, Tokyo (JP)

(72) Inventors: Akira ICHIKI, Kanagawa (JP); Masaki HACHIYA, Kanagawa (JP); Takuya INOUE, Kanagawa (JP)

(73) Assignee: FUJIFILM Corporation, Tokyo (JP)

(21) Appl. No.: 16/381,561

(22) Filed: Apr. 11, 2019

Related U.S. Application Data
(63) Continuation of application No. PCT/JP2017/036663, filed on Oct. 10, 2017.

(30) Foreign Application Priority Data
Oct. 25, 2016 (JP) 2016-209083

(51) Int. Cl. G06F 3/047; G06F 3/041

(52) U.S. Cl. CPC G06F 3/047; G06F 3/0414

(57) ABSTRACT

A conductive sheet for a touch sensor including a base material, a pattern-like conductive portion that is disposed on the base material and is made of a fine metal wire, and a transparent insulation layer disposed on the conductive portion, in which the transparent insulation layer is a layer formed using a composition for forming the transparent insulation layer including a predetermined compound.

### CROSS-REFERENCE TO RELATED APPLICATIONS

This application is a Continuation of PCT International Application No. PCT/JP2017/036663, filed on Oct. 10, 2017, which claims priority under 35 U.S.C. § 119(a) to Japanese Patent Application No. 2016-209083, filed on Oct. 25, 2016. Each of the above application(s) is hereby expressly incorporated by reference, in its entirety, into the present application.

### BACKGROUND OF THE INVENTION

### 1. Field of the Invention

The present invention relates to a conductive sheet for a touch sensor, a method for manufacturing a conductive sheet for a touch sensor, a touch sensor, a touch panel laminate, a touch panel, and a composition for forming a transparent insulation layer.

### 2. Description of the Related Art

Recently, in a variety of electronic devices such as portable information devices, touch panels which are used in combination with a display device such as a liquid crystal display device and on which an input operation to an electronic device is carried out by touching a screen have been distributed.

Generally, a touch panel is manufactured by attaching individual members (a glass substrate, a conductive sheet for a touch sensor, a display device, and the like) through pressure-sensitive adhesive films such as optical clear adhesive (OCA) films.

Generally, the conductive sheet for a touch sensor has a conductive portion made of a pattern-like fine metal wire that serves as a detection electrode (sensor electrode) or a drawing wire (ambient electrode) on a base material.

At the present, there are cases in which a transparent insulation layer is formed as a protective film on the surface of the conductive portion of the conductive sheet for a touch sensor for the purpose of improving handleability or for the purpose of improving the abrasion resistance or solvent resistance of the conductive portion that serves as the detection electrode or the drawing wire. Unlike peelable protective films (peeling films) for temporarily protecting surfaces of conductive sheets for a touch sensor during manufacturing steps, the transparent insulation layer is not peeled off from the surface of the conductive portion. That is, for example, in the case of producing an electrostatic capacitance-type touch panel using a conductive sheet for a touch sensor in which the surface of a conductive portion is protected with a transparent insulation layer, a glass substrate is disposed on the transparent insulation layer through a pressure-sensitive adhesive layer.

For example, JP2015-524961A discloses “a transparent conductive film including a transparent base including a main body including a detection region and a frame region located at an edge of the detection region and a flexible substrate that is formed so as to extend from one side of the main body and has a width that is smaller than the width of the main body, a wire for conduction that is provided in the transparent base, a grid-shaped first conductive layer that includes first conductive wires that intersect one another and is provided on one side of the detection region, a grid-shaped second conductive layer that includes second conductive wires that intersect one another and is provided on one side of the detection region opposite to the first conductive layer, a first lead wire electrode that is provided on one side of the frame region and electrically connects the first conductive layer and the wire for conduction, and a second lead wire electrode that is provided on the other side of the frame region and electrically connects the second conductive layer and the wire for conduction”. JP2015-524961A describes in Paragraph <0056> that a transparent protective layer that at least partially coats a first conductive layer 20 and a second conductive layer 30 that serve as detection electrodes, a first lead wire electrode 40 and a second lead wire electrode 50 that serve as drawing wires, and the like may be installed during the production of a touch panel. In addition, as a material of the transparent protective layer, an ultraviolet-curable adhesive (UV adhesive) and the like are exemplified.

### SUMMARY OF THE INVENTION

As a result of producing a conductive sheet for a touch sensor in which a transparent protective layer (transparent insulation layer) is disposed using an ultraviolet-curable adhesive as described in JP2015-524961A and carrying out studies, the present inventors found that, particularly, in a case in which a conductive portion is constituted of a mesh pattern made of a fine metal wire, there is a case in which the levelability of the surface of the transparent insulation layer (in other words, “flatness is excellent” and “there are no spots of film-free regions and a film is formed throughout the entire surface (the cissing resistance are excellent)”) becomes insufficient or the transparent insulation layer cannot be formed at a predetermined location on a mesh pattern.

In the case of imparting the composition for forming a transparent insulation layer, the conductive portion has a pattern shape, and thus the composition for forming a transparent insulation layer is disposed so as to cover a surface (a region in which the conductive portion is not formed) of a base material on a conductive portion side and the conductive portion. That is, for example, in a case in which the conductive portion is constituted of a mesh pattern made of a fine metal wire, a region in which the mesh pattern made of a fine metal wire is formed forms a three-dimensional portion (protrusion portion) with respect to the base material, and a coated film is formed so as to come into contact with the fine metal wire constituting the mesh pattern and the surface of the base material in which the mesh pattern is not formed. As a result of the present inventors' studies, it has been confirmed that, due to the above-described structure and the difference in free energy between the fine metal wire and the base material, there is a problem in that an air bubble trace remains, a protrusion and a recess are generated on the surface of the coated film, spots of film-free regions in which the film is not formed are generated in the coated film due to cissing, or the coated film contracts and the film is not formed at a predetermined location of the mesh pattern. Particularly, it has been clarified that, in a case in which the thickness of the mesh pattern made of a fine metal wire is great, performance further degrades.

Transparent insulation layers obtained by curing the above-described coated film through exposure have a disadvantage that, consequently, the levelability of the surface is poor and the film is not formed at a predetermined location of the mesh pattern.

Meanwhile, as a result of carrying out studies using a surface modifier in order to solve the cissing, air bubble traces, and levelability of the transparent insulation layer, the present inventors found that, although the levelability improves, transparent insulation layers to be formed have a problem in that the adhesiveness to pressure-sensitive adhesive sheets that are used to produce touch panels and the like degrades.

Therefore, an object of the present invention is to provide a conductive sheet for a touch sensor having, at a predetermined location, a transparent insulation layer being excellent in terms of the adhesiveness to pressure-sensitive adhesive sheets that are used to produce touch panels and the like and being also excellent in terms of the levelability and a manufacturing method therefor.

In addition, an object of the present invention is to provide a touch sensor, a touch panel laminate, and a touch panel which include the conductive sheet for a touch sensor.

In addition, an object of the present invention is to provide a composition for forming a transparent insulation layer capable of imparting a conductive sheet for a touch sensor having, at a predetermined location, a transparent insulation layer being excellent in terms of the adhesiveness to pressure-sensitive adhesive sheets that are used to produce touch panels and the like and being also excellent in terms of the levelability.

As a result of intensive studies for achieving the above-described objects, the present inventors found that, in a case in which a composition for forming a transparent insulation layer for forming a transparent insulation layer contains a compound having a specific structure, the above-described objects can be achieved and completed the present invention.

That is, it was found that the above-described object can be achieved by the following constitutions.

(1) A conductive sheet for a touch sensor comprising:

a base material;

a pattern-like conductive portion that is disposed on the base material and is made of a fine metal wire; and

a transparent insulation layer disposed on the conductive portion,

in which the transparent insulation layer is a layer formed using a composition for forming the transparent insulation layer including a compound A, and the compound A is an oligomer including at least one selected from isobutylene, propylene, or butene in a structure.

(2) A conductive sheet for a touch sensor, in which the composition for forming a transparent insulation layer is, furthermore, a layer formed using a composition for forming a transparent insulation layer including a compound B, and the compound B includes an adipic acid structure.

(3) The conductive sheet for a touch sensor according to (1) or (2), in which the composition for forming a transparent insulation layer further includes a polymerizable compound having a (meth)acryloyl group and a polymerization initiator.

(4) The conductive sheet for a touch sensor according to any one of (1) to (3), in which the composition for forming a transparent insulation layer further includes a compound including a siloxane structural unit.

(5) The conductive sheet for a touch sensor according to any one of (1) to (4), in which a surface tension of the composition for forming a transparent insulation layer is 35 mN/m or less at 25° C.

(6) A conductive sheet for a touch sensor comprising:

a base material;

a pattern-like conductive portion that is disposed on the base material and is made of a fine metal wire; and

a transparent insulation layer disposed on the conductive portion,

in which the transparent insulation layer includes a compound C, and

the compound C is an oligomer including at least one selected from isobutylene, propylene, or butene in a structure.

(7) The conductive sheet for a touch sensor according to (6), in which the transparent insulation layer further includes a compound D, and the compound D includes an adipic acid structure.

(8) The conductive sheet for a touch sensor according to any one of (6) and (7), in which the transparent insulation layer further includes a (meth)acryloyl resin having a crosslinking structure.

(9) The conductive sheet for a touch sensor according to any one of (6) to (8), in which the transparent insulation layer further includes a compound including a siloxane structural unit.

(10) The conductive sheet for a touch sensor according to any one of (1) to (9), in which a surface energy of the transparent insulation layer is 30 mN/m or less at 25° C.

(11) The conductive sheet for a touch sensor according to any one of (1) to (10), in which the conductive portions are respectively disposed on both surfaces of the base material and have a mesh pattern made of a fine silver wire.

(12) A method for manufacturing the conductive sheet for a touch sensor according to any one of (1) to (11), the method comprising: a transparent insulation layer-forming step of forming the transparent insulation layer on the base material and the conductive portion using a screen printing method.

(13) A touch sensor comprising: the conductive sheet for a touch sensor according to any one of (1) to (12).

(14) A touch panel laminate comprising in order: the conductive sheet for a touch sensor according to any one of (1) to (12); a pressure-sensitive adhesive sheet; and a peeling sheet.

(15) A touch panel comprising: the touch sensor according to (13).

(16) A composition for forming a transparent insulation layer that is used to manufacture a conductive sheet for a touch sensor and is applied to a surface of a pattern-like conductive portion made of a fine metal wire,

in which the composition for forming a transparent insulation layer includes a compound A, and

the compound A is an oligomer including at least one selected from isobutylene, propylene, or butene in a structure.

(17) The composition for forming a transparent insulation layer according to (16), in which a surface tension of the composition for forming a transparent insulation layer is 35 mN/m or less at 25° C.

According to the present invention, it is possible to provide a conductive sheet for a touch sensor having, at a predetermined location, a transparent insulation layer being excellent in terms of the adhesiveness to pressure-sensitive adhesive sheets that are used to produce touch panels and the like and being also excellent in terms of the levelability and a manufacturing method therefor.

In addition, it is possible to provide a touch sensor, a touch panel laminate, and a touch panel which include the conductive sheet for a touch sensor.

In addition, according to the present invention, it is possible to provide a composition for forming a transparent insulation layer capable of imparting a conductive sheet for a touch sensor having, at a predetermined location, a transparent insulation layer being excellent in terms of the adhesiveness to pressure-sensitive adhesive sheets that are used to produce touch panels and the like and being also excellent in terms of the levelability.

### BRIEF DESCRIPTION OF THE DRAWINGS

FIG. 1 is a partial cross-sectional view of a first embodiment of a conductive sheet for a touch sensor.

FIG. 2 is a partial plan view of the first embodiment of the conductive sheet for a touch sensor.

FIG. 3 is a cross-sectional view of a first embodiment of an electrostatic capacitance-type touch panel.

FIG. 4 is a plan view of the first embodiment of the electrostatic capacitance-type touch sensor.

FIG. 5 is a cross-sectional view cut along a cutting line V-V illustrated in FIG. 4.

FIG. 6 is an enlarged plan view of a first detection electrode.

### DESCRIPTION OF THE PREFERRED EMBODIMENTS

Hereinafter, the present invention will be described in detail.

Constituent requirements described below will be described on the basis of a representative embodiment of the present invention in some cases, but the present invention is not limited to the above-described embodiment.

Meanwhile, in the present specification, numerical ranges expressed using “to” include numerical values before and after “to” as the lower limit value and the upper limit value.

In the present specification, regarding the expression of a group (group of atoms), an expression of a group that is not described as substituted or unsubstituted refers to both a group not having any substituent and a group having a substituent as long as the effects of the present invention are not impaired. For example, “an alkyl group” refers to not only an alkyl group not having any substituent (unsubstituted alkyl group) but also an alkyl group having a substituent (substituted alkyl group). The above description will also be true for individual compounds.

In addition, light in the present specification, refers to an active light ray or a radiant ray. “Exposure to light” in the present specification refers not only to exposure to light such as a mercury lamp, a far-ultraviolet ray represented by an excimer laser, X-rays, or EUV light but also to the exposure of a drawing to a particle ray such as an electron beam or an ion beam unless particularly otherwise described.

In addition, in the present specification, “(meth)acrylate” refers to any one or both of acrylate and methacrylate, and “(meth)acryl” refers to any one of both of acryl and methacryl. In addition, “(meth)acryloyl” refers to any one or both of acryloyl and methacryloyl.

[Conductive Sheet for Touch Sensor]

A conductive sheet for a touch sensor of the embodiment of the present invention is a conductive sheet for a touch sensor including

a base material,

a pattern-like conductive portion that is disposed on the base material and is made of a fine metal wire, and

a transparent insulation layer disposed so as to cover a surface of the base material on a conductive portion side and the conductive portion,

in which the transparent insulation layer is a layer formed using a composition for forming the transparent insulation layer including a compound A described below.

The conductive sheet for a touch sensor of the embodiment of the present invention is provided with the above-described constitution, thereby having, at a predetermined location, a transparent insulation layer being excellent in terms of the adhesiveness to pressure-sensitive adhesive sheets that are used to produce touch panels and the like and being also excellent in terms of the levelability.

A characteristic of the conductive sheet for a touch sensor of the embodiment of the present invention is that the transparent insulation layer is formed using the composition for forming a transparent insulation layer including the compound A.

The compound A has at least one structure selected from isobutylene, propylene, or butene. In the case of using the compound A, the composition for forming a transparent insulation layer favorably spreads on both the base material and a mesh pattern that forms a protrusion portion with respect to the base material and does not easily generate air bubble traces even in a case in which the conductive portion is constituted of the mesh pattern made of a fine metal wire. As a result, coated films to be coated are excellent in terms of the cissing resistance, and the contraction of the coated films is suppressed, whereby it is possible to form the transparent insulation layer at a predetermined location of the mesh pattern. The compound A may be an oligomer including all of polyisobutylene, a polypropylene, and polybutene or may be a mixture of oligomers of the respective single bodies or a plurality of oligomers including two kinds of structures. The amounts of the respective units are not particularly limited, but the unit ratio between isobutylene and propylene or butene is preferably 0:1 to 1:0 and more preferably 0.1:1 to 1:0.1. The unit ratio between propylene and butene is not limited, but is more preferably 0.1:1 to 1:0.1. The molecular weight of the compound A is preferably 100 to 20,000.

In addition, the transparent insulation layer (a layer including a compound C described below) formed by curing the coated film does not easily generate air bubble traces, is excellent in terms of the levelability, and can be located at a predetermined location of the mesh pattern. In addition, it is confirmed that the transparent insulation layer is also favorable in terms of the adhesiveness to pressure-sensitive adhesive sheets that are used to produce touch panels and the like.

In addition, at this time, the present inventors found that an insulation film that is excellent in terms of the levelability can be selected by evaluating components in the film of the formed transparent insulation layer. That is, it is found that, in a case in which the film of the transparent insulation layer includes a compound including at least one structure selected from isobutylene, propylene, or butene, point defects are not easily generated in the transparent insulation layer, and the levelability is excellent. A transparent insulation layer in the above-described constitution is considered to be a structure in which a polyolefin structure that effectively decreases the surface tension in a liquid state in an acrylic group is disposed and be in a state of excellent compatibility so that the transparent insulation layer has a defoaming property during the formation of the film, and, consequently, it is assumed that air bubble traces are not easily generated and a favorable levelability can be realized. Isobutylene, propylene, and butene may be included as an oligomer including all of isobutylene, propylene, and butene or may be in a mixed state of oligomers of the respective single bodies or a plurality of oligomers including two kinds of structures.

The amounts of the respective units are not particularly limited, but the unit ratio between isobutylene and propylene or butene is preferably 0:1 to 1:0 and more preferably 0.1:1 to 1:0.1.

The unit ratio between propylene and butene is not limited, but is preferably 0:1 to 1:0.1 and more preferably 0.1:1 to 1:0.1.

The presence and absence, kind, and amount of a polyolefin in the film can be preferably identified by extracting the polyolefin from the transparent insulation layer using a solvent such as hexane and carrying out an analysis in which pyrolysis-GC-MS is carried out.

Hereinafter, a preferred aspect of the conductive sheet for a touch sensor of the embodiment of the present invention will be described with reference to drawings.

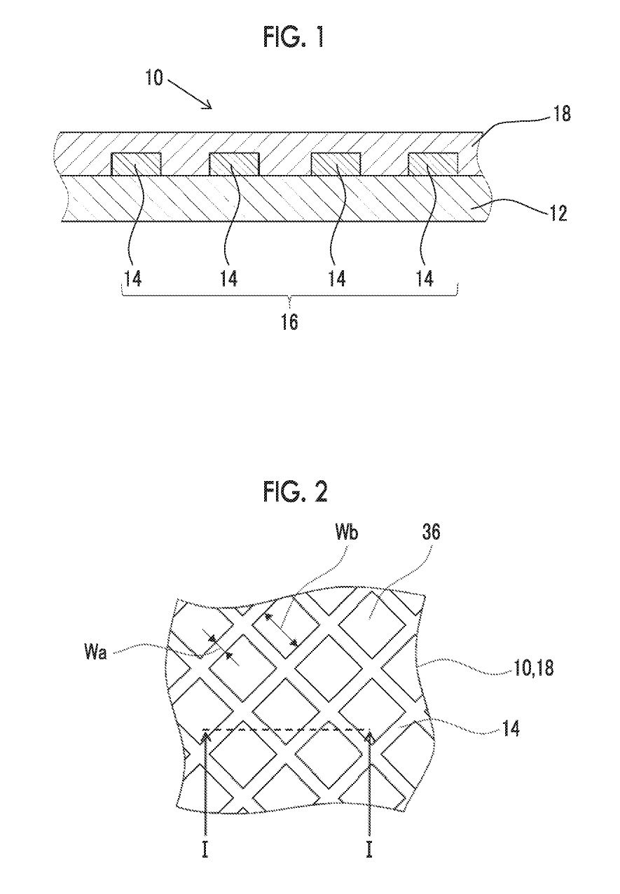

FIG. 1 illustrates a partial cross-sectional view of a first embodiment of a conductive sheet for a touch sensor 10. In addition, FIG. 2 is a partial plan view of the first embodiment of the conductive sheet for a touch sensor 10. Meanwhile, FIG. 1 is a cross-sectional view cut along a cutting line I-I illustrated in FIG. 2. The conductive sheet for a touch sensor 10 comprises a base material 12, a conductive portion 16 that is disposed on the base material 12 and is made of a plurality of fine metal wires 14, and a transparent insulation layer 18 disposed on the conductive portion 16 (in other words, disposed so as to come into contact with a surface of the base material 12 and the conductive portion 16). Meanwhile, as illustrated in FIG. 2, the conductive portion 16 has a mesh pattern constituted of the fine metal wires 14.

Hereinafter, the respective members constituting the conductive sheet for a touch sensor will be described in detail.

<<Base Material>>

The kind of the base material is not limited as long as the base material is capable of supporting the conductive portion, but a transparent base material is preferred, and a plastic film is more preferred.

As a specific example of a material constituting the base material, a plastic film having a melting point of approximately 290° C. or lower such as polyethylene terephthalate (PET) (258° C.), polycycloolefin (134° C.), polycarbonate (250° C.), a (meth)acrylic resin (128° C.), polyethylene naphthalate (PEN) (269° C.), polyethylene (PE) (135° C.), polypropylene (PP) (163° C.), polystyrene (230° C.), polyvinyl chloride (180° C.), polyvinylidene chloride (212° C.), or triacetyl cellulose (TAC) (290° C.) is preferred, a (meth)acrylic resin, PET, polycycloolefin, or polycarbonate is more preferred, and a (meth)acrylic resin is still more preferred from the viewpoint of the adhesiveness to the transparent insulation layer that becomes an upper layer. Numerical values in the parentheses are melting points. A total light transmittance of the base material is preferably 85% to 100%.

A thickness of the base material is not particularly limited and, generally, can be arbitrarily selected in a range of 25 to 500 μm from the viewpoint of the application to touch panels. Meanwhile, in the case of providing a function as a touching surface in addition to the functions of the base material, the base material can be designed in a thickness of more than 500 μm.

As another preferred aspect, the base material preferably has an undercoat layer including a polymer on the surface. The adhesiveness of the conductive portion is further improved by forming the conductive portion on the undercoat layer.

A method for forming the undercoat layer is not particularly limited, and examples thereof include a method in which a composition for forming the undercoat layer including a polymer is applied onto the base material and a heating treatment is carried out as necessary.

The composition for forming the undercoat layer may include a solvent as necessary. The kind of the solvent is not particularly limited, and well-known solvents are exemplified. In addition, as the composition for forming the undercoat layer including a polymer, a latex including the fine particles of a polymer may also be used.

A thickness of the undercoat layer is not particularly limited, but is preferably 0.02 to 0.3 μm and more preferably 0.03 to 0.2 μm from the viewpoint of the adhesiveness of the conductive portion.

<<Conductive Portion>>

The conductive portion 16 is disposed on the base material 12 and has a mesh pattern made of a plurality of fine metal wires 14. The conductive portion 16 preferably constitutes mainly a sensor portion in a touch sensor as described below.

As illustrated in FIG. 2, the conductive portion 16 has a mesh pattern made of the plurality of fine metal wires 14. That is, the conductive portion includes a plurality of opening portions (lattice) 36 formed by the intersecting fine metal wires 14.

A line width Wa of the fine metal wire 14 is not particularly limited, but is preferably 30 μm or less, more preferably 15 μm or less, still more preferably 10 μm or less, particularly preferably 9 μm or less, and most preferably 7 μm or less, and is preferably 0.5 μm or more and more preferably 1.0 μm or more. In a case in which the line width is in the above-described range, it is possible to relatively easily form an electrode having a low resistance.

A thickness of the fine metal wire 14 is not particularly limited and can be selected from 0.00001 mm to 0.2 mm from the viewpoint of the conductive property and the visibility, but is preferably 30 μm or less, still more preferably 20 μm or less, still more preferably 0.01 to 9 μm, and particularly preferably 0.05 to 5 μm.

There is a tendency that, as the thickness of the fine metal wire 14 increases, the levelability of the transparent insulation layer described below degrades. Therefore, the effects of the present invention can be further benefited in a case in which the thickness of the fine metal wire 14 is 0.0002 mm or more, particularly, 0.0004 mm or more.

The opening portion 36 is an open region surrounded by the fine metal wires 14. A length Wb of a side of the opening portion 36 is preferably 800 μm or less, more preferably 600 μm or less, and still more preferably 400 μm or less, and is preferably 5 μm or more, more preferably 30 μm or more, and still more preferably 80 μm or more. An array pitch of the fine metal wires 14 is preferably the numerical range of the Wb. Meanwhile, in the present specification, the array pitch of the fine metal wire refers to the total length of the Wa and the Wb (the total length of the line width of the fine metal wire and the width of the opening portion).

From the viewpoint of the visible light transmittance, an opening ratio is preferably 85% or more, more preferably 90% or more, and still more preferably 95% or more. The opening ratio corresponds to a proportion of transmissive portions (the opening portions) excluding the fine metal wires 14 in the entire mesh shape in the conductive portion 16.

In FIG. 2, the opening portion 36 has a substantially diamond shape. However, the opening portion may have, additionally, a polygonal shape (for example, a triangular shape, a quadrangular shape, a hexagonal shape, or a random polygonal shape). In addition, the shape of the side may be, in addition to a straight shape, a curved shape or may be an arc shape. In a case in which the side of the opening portion has an arc shape, for example, two facing sides may have an arc shape protruding outwards, and the remaining two facing sides may have an arc shape protruding inwards. In addition, the respective sides may have a wavy line shape in which arcs protruding outwards and arc protruding inwards continue. It is needless to say that the shape of each side may be a sine curve.

Furthermore, in FIG. 2, a mesh-like pattern is described, but the pattern shape of the fine metal wires is not limited to this aspect.

Examples of a material of the fine metal wire 14 include metals such as gold (Au), silver (Ag), copper (Cu), and aluminum (Al), alloys, and the like. Among these, silver is preferred since the conductive property of the fine metal wire 14 is excellent.

The fine metal wire 14 preferably includes a binder from the viewpoint of the adhesiveness between the fine metal wire 14 and the base material 12.

As the binder, at least any resin selected from the group consisting of (meth)acrylic resins, styrene-based resins, vinyl-based resins, polyolefin-based resins, polyester-based resins, polyurethane-based resins, polyamide-based resins, polycarbonate-based resins, polydiene-based resins, epoxy-based resins, silicone-based resins, cellulose-based polymers, and chitosan-based polymers, a copolymer formed of a monomer constituting the above-described resins, or the like is exemplified since the adhesiveness between the fine metal wire 14 and the base material 12 is more favorable.

A method for manufacturing the fine metal wire 14 is not particularly limited, and a well-known method can be employed. Examples thereof include a method in which silver halide is used which will be described below. This method will be described below in detail.

<<Transparent Insulation Layer>>

The transparent insulation layer 18 is disposed on the conductive portion 16. More specifically, the transparent insulation layer 18 is disposed on a surface (a region in which the conductive portion 16 is not present) of the base material 12 and the conductive portion 16 so as to cover the surface of the base material and the conductive portion. That is, the conductive portion 16 has a pattern shape, and thus the transparent insulation layer 18 is in contact with the surface of the base material 12 and the pattern portion that constitutes the conductive portion 16.

In a case in which the conductive sheet for a touch sensor 10 is used in, for example, an electrostatic capacitance-type touch panel as described below, other members such as a glass substrate are disposed on the transparent insulation layer 18 through a pressure-sensitive adhesive sheet (pressure-sensitive adhesive layer).

The transparent insulation layer 18 preferably has solvent resistance, abrasion resistance, and bending resistance.

Hereinafter, individual components constituting the transparent insulation layer will be described.

A composition of a compound that is included in the transparent insulation layer (a first embodiment) and the transparent insulation layer (a second embodiment) will be described.

First, the transparent insulation layer (the second embodiment) will be described.

The transparent insulation layer includes a compound C.

The compound C has an oligomer form including at least one structure selected from isobutylene, propylene, or butene. The compound may be an oligomer including all of isobutylene, propylene, and butene or may be a mixture of oligomers of the respective single bodies or a plurality of oligomers including two kinds of structures. The amounts of the respective units are not particularly limited, but the unit ratio between isobutylene and propylene or butene is preferably 0:1 to 1:0 and more preferably 0.1:1 to 1:0.1. The unit ratio between propylene and butene is not limited, but is preferably 0:1 to 1:0 and more preferably 0.1:1 to 1:0.1. The molecular weight of the compound A is preferably 100 to 20,000.

A content of the compound C is preferably 0.001% to 10% by mass of the total mass of the transparent insulation layer. In a case in which the content of the compound C in the transparent insulation layer is set to 0.01% by mass or more, the intrusion of air bubble traces is prevented, and the levelability is excellent. The content of the compound C is more preferably 0.01% to 5% by mass, still more preferably 0.01% to 2% by mass, and particularly preferably 0.05% to 1% by mass of the total mass of the transparent insulation layer.

The transparent insulation layer preferably includes a compound D. The compound D includes an adipic acid structure. As a compound including an adipic acid structure, compounds in which a terminal of an adipic acid structure becomes —OH, an alkyl, an amide, other aromatic groups, or a substituent structure including all of —OH, an alkyl, an amide, and other aromatic groups, and specific examples thereof include bis(2-ethylhexyl) adipate, bis[2-(2-butoxyethoxy)ethyl] adipate, di-n-alkyl adipate (the number of carbon atoms in the alkyl group is 6, 8, or 10), diisooctadecyl adipate, diisononyl adipate, and the like.

A content of the compound D is preferably 0.001% to 10% by mass of the total mass of the transparent insulation layer. In a case in which the content of the compound D in the transparent insulation layer is set to 0.001% by mass or more, there is a case in which the intrusion of air bubble traces can be prevented and the levelability can be reinforced. The content of the compound D is more preferably 0.001% to 0.5% by mass, still more preferably 0.001% to 0.2% by mass, and particularly preferably 0.005% to 0.1% by mass of the total mass of the transparent insulation layer.

The transparent insulation layer also preferably includes a compound having a siloxane structural unit. In such a case, the transparent insulation layer is capable of having more favorable flatness.

As a compound having a siloxane structural unit, particularly, compounds having a siloxane structural unit represented by Formula (1) to Formula (3) are preferred.

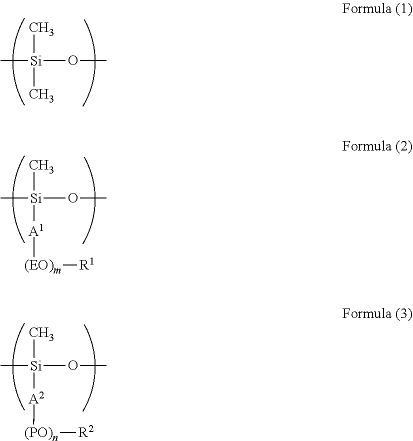

In Formula (2) and Formula (3), A¹ and A² each independently represent a single bond or a divalent organic group, EO represents an oxyethylene group, m represents the number of the oxyethylene groups, PO represents an oxypropylene group, n represents the number of the oxypropylene groups, and R¹ and R² each independently represent a hydrogen atom, an alkyl group, or a (meth)acryloyl group.

In Formula (2) and Formula (3), as the divalent organic group represented by A¹ and A², substituted or unsubstituted divalent aliphatic hydrocarbon groups (for example, the number of carbon atoms is 1 to 8; for example, an alkylene group such as a methyl group, an ethyl group, or a propylene group), substituted or unsubstituted divalent aromatic hydrocarbon groups (for example, the number of carbon atoms is 6 to 12; for example, a phenylene group), —O—, —S—, —SO2—, —N(R)— (R: alkyl group), —CO—, —NH—, —COO—, —CONH—, groups formed by combining the above-described groups (for example, an alkyleneoxy group, an alkyleneoxy carbonyl group, an alkylene carbonyl group, and the like), and the like.

In Formula (2) and Formula (3), m and n each is independently preferably 1 to 200 and more preferably 1 to 100.

In addition, the oxypropylene group (PO) may be any of a straight chain or a branch.

In the alkyl group represented by R¹ and R², the number of carbon atoms is preferably 1 to 10 and more preferably 1 to 5. Examples of the alkyl group represented by R¹ and R² include a methyl group and an ethyl group.

The compound having a siloxane structure may further have a structural unit other than the siloxane structural unit represented by Formula (1) to Formula (3), but the total content of the structural unit represented by Formula (1) to Formula (3) is preferably 50 mol % or more of the total structural units, more preferably 80 mol % or more of the total structural units, and still more preferably 90 mol % or more of the total structural units.

Specific examples of the compound having a siloxane structure that can be used in the present invention include BYK-333, BYK-307, BYK-302 (manufactured by BYK Japan KK), TEGOrad2100 (manufactured by Evonik), and the like. In the present invention, BYK-333 and BYK-307 are preferred.

The transparent insulation layer preferably includes a (meth)acrylic resin having a crosslinking structure since the adhesiveness to the base material and the conductive portion which are underlayers is superior, and, furthermore, the weather resistance is excellent. In addition, the surface energy is preferably 30 mN/m or less and more preferably 28 mN/m or less at 25° C. from the viewpoint of producing films capable of developing the levelability. From the viewpoint of the adhesive force, the surface energy is preferably not too low, and the lower limit value is preferably 10 mN/m or more and more preferably 20 mN/m or more.

There is a case in which an easily adhesive protective film or an optically clear adhesive (OCA) is attached to the surface of the transparent insulation layer, and it is preferable that an appropriate value can be obtained as the adhesive force. In the case of an easily adhesive protective film, the adhesive force is preferably 0.1 N/25 mm or more, and, in the case of a member that is used in an attached form such as an optically clear adhesive (OCA), the adhesive force is preferably 5 N/25 mm or more.

A thickness of the transparent insulation layer is not particularly limited; however, in a case in which the thickness is large, cracks are likely to be generated when the transparent insulation layer is bent. The thickness is preferably 1 to 20 μm and more preferably 5 to 15 μm from the viewpoint of the transparent insulation layer being superior in terms of the adhesiveness to the conductive portion and the film strength while suppressing cracks.

An indentation hardness of the transparent insulation layer is preferably 0.01 MPa to 200 MPa, and the upper limit value is more preferably 140 MPa or less. In a case in which the indentation hardness is set in the above-described range, the transparent insulation layer has flexibility, and cracks are not easily generated in the transparent insulation layer even in a case in which the conductive sheet for a touch sensor is bent and used.

The indentation hardness of the transparent insulation layer can be measured using a microhardness tester (PICODENT).

A modulus of elasticity at 50° C. to 90° C. of the transparent insulation layer is preferably 1×10⁶ Pa or more. In a case in which the base material thermally expands, the fine metal wires which are formed on the base material and have an expansion factor that is lower than that of the base material also extend in the same manner, which generates cracks in the fine metal wires in some cases. Particularly, in a case in which the conductive sheet for a touch sensor is used in a state of being bent, there is a case in which the fine metal wires break. The cracks or the breakage of the fine metal wires can be suppressed by setting the modulus of elasticity at 50° C. to 90° C. of the transparent insulation layer to 1×10⁶ Pa or more. Meanwhile, the modulus of elasticity of the transparent insulation layer can be measured using a microhardness tester (PICODENT).

The total light transmittance of the conductive sheet for a touch sensor including the transparent insulation layer is preferably 85% or more and more preferably 90% or more in the visible light range (wavelengths: 400 to 700 nm).

Meanwhile, the total light transmittance is a value measured using a spectrophotometer CM-3600A (manufactured by Konica Minolta. Inc.).

Meanwhile, the total light transmittance of the transparent insulation layer is preferably adjusted so that the conductive sheet for a touch sensor exhibits the above-described total light transmittance and preferably at least 85% or more.

In order to suppress a decrease in the conductivity attributed to differences in linear expansion coefficient among the base material, the conductive portion, and the transparent insulation layer, the difference between the linear expansion coefficient of the transparent insulation layer and the linear expansion coefficient of the base material is preferably small, and the degree of the difference is preferably 300 ppm/° C. or less and more preferably 150 ppm/° C. or less.

The transparent insulation layer preferably has an excellent adhesiveness to the conductive portion, and, specifically, the transparent insulation layer is preferably not peeled off in a tape adhesive force evaluation test using “610” manufactured by 3M.

In addition, the transparent insulation layer is in contact not only with the conductive portion but also with the region of the base material (or the undercoat layer or a binder layer) in which the conductive portion is not formed and thus preferably has an excellent adhesiveness to the base material (or the undercoat layer or the binder layer). In a case in which the adhesiveness of the transparent insulation layer to the base material (or the undercoat layer or the binder layer) is poor, the transparent insulation layer is adhered only to the conductive portion, and thus, in a case in which “the liner expansion coefficient of the transparent insulation layer is greater than the linear expansion coefficient of the conductive portion”, a force is applied to the conductive portion, and there is a concern that the pattern shape of the conductive portion may change. Meanwhile, the binder layer refers to a layer that is disposed on the base material and between the fine metal wires and formed of a binder and is often formed in the case of manufacturing fine metal wires using a silver halide method.

From the viewpoint of suppressing the surface reflection of the conductive sheet for a touch sensor, a refractive index difference between a refractive index of the transparent insulation layer and a refractive index of the base material is preferably small.

In addition, in a case in which a binder component is included in the fine metal wires of the conductive portion, a refractive index difference between the refractive index of the transparent insulation layer and a refractive index of the binder component is preferably small, and a resin component forming the transparent insulation layer and the binder component are more preferably the same material.

Meanwhile, as an example of the resin component forming the transparent insulation layer and the binder component being the same material, a case in which both the binder component and the resin component forming the transparent insulation layer are a (meth)acrylic resin can be exemplified.

Furthermore, in a case in which the conductive sheet for a touch sensor is applied to, for example, a touch panel as described above, a pressure-sensitive adhesive sheet (pressure-sensitive adhesive layer) is attached to the transparent insulation layer of the conductive sheet for a touch sensor. A refractive index difference between the refractive index of the transparent insulation layer and a refractive index of the pressure-sensitive adhesive sheet is preferably small in order to suppress light scattering in an interface between the transparent insulation layer and the pressure-sensitive adhesive sheet.

A method for forming the transparent insulation layer on the base material and the conductive portion is not particularly limited. Examples thereof include a method in which the composition for forming a transparent insulation layer including a compound A described below and a variety of components that are randomly added is applied onto the base material and the conductive portion, thereby forming the transparent insulation layer (coating method), a method in which the transparent insulation layer is formed on a temporary substrate and transferred to the surface of the conductive portion (transfer method), and the like. Among these, the coating method is preferred from the viewpoint of the easiness of controlling the thickness.

Hereinafter, individual components of the composition for forming the transparent insulation layer capable of forming the transparent insulation layer and a method for forming the transparent insulation layer will be described in detail.

<Composition for Forming Transparent Insulation Layer>

Hereinafter, individual components of the composition for forming a transparent insulation layer (the first embodiment) capable of forming the transparent insulation layer (the second embodiment) will be described in detail.

(Compound A)

The composition for forming a transparent insulation layer contains the compound A.

The compound A has at least one structure selected from isobutylene, propylene, or butene. The compound A may be an oligomer including all of polyisobutylene, a polypropylene, and polybutene or may be a mixture of oligomers of the respective single bodies or a plurality of oligomers including two kinds of structures. The amounts of the respective units are not particularly limited, but the unit ratio between isobutylene and propylene or butene is preferably 0:1 to 1:0 and more preferably 0.1:1 to 1:0.1. The unit ratio between propylene and butene is not limited, but is more preferably 0:1 to 1:0.1 and preferably 0.1:1 to 1:0.1. The molecular weight of the compound A is preferably 100 to 20,000.

Specific examples of the compound A that can be used in the present invention include FLOWLEN AC-2300C (manufactured by Kyoeisha Chemical Co., Ltd.) and the like.

The composition for forming a transparent insulation layer preferably includes a compound B. The compound B includes an adipic acid structure. As a compound including an adipic acid structure, compounds in which a terminal of an adipic acid structure becomes —OH, an alkyl, an amide, other aromatic groups, or a substituent structure including all of —OH, an alkyl, an amide, and other aromatic groups, and specific examples thereof include bis(2-ethylhexyl) adipate, bis[2-(2-butoxyethoxy)ethyl] adipate, di-n-alkyl adipate (the number of carbon atoms in the alkyl group is 6, 8, or 10), diisooctadecyl adipate, diisononyl adipate, and the like.

A content of the compound B is preferably 0.001% to 10% by mass of the total mass of the composition for forming a transparent insulation layer. In a case in which the content of the compound B in the composition for forming a transparent insulation layer is set to 0.001% by mass or more, there is a case in which the intrusion of air bubble traces can be prevented and the levelability can be reinforced. The content of the compound B is more preferably 0.001% to 0.5% by mass, still more preferably 0.001% to 0.2% by mass, and particularly preferably 0.005% to 0.1% by mass of the total mass of the composition for forming a transparent insulation layer.

The composition for forming a transparent insulation layer also preferably includes a compound having a siloxane structural unit. In such a case, the composition for forming a transparent insulation layer is capable of having more favorable flatness.

As a compound having a siloxane structural unit, particularly, compounds having a siloxane structural unit represented by Formula (1) to Formula (3) are preferred.

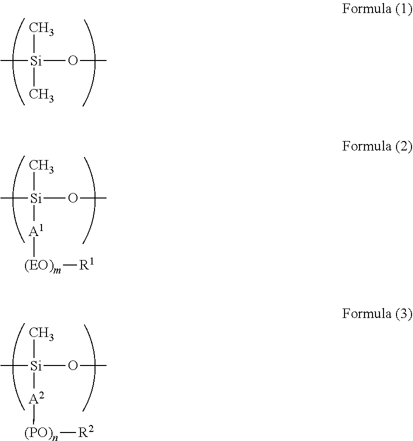

In Formula (2) and Formula (3), A¹ and A² each independently represent a single bond or a divalent organic group, EO represents an oxyethylene group, m represents the number of the oxyethylene groups, PO represents an oxypropylene group, n represents the number of the oxypropylene groups, and R¹ and R² each independently represent a hydrogen atom, an alkyl group, or a (meth)acryloyl group.

In Formula (2) and Formula (3), as the divalent organic group represented by A¹ and A², substituted or unsubstituted divalent aliphatic hydrocarbon groups (for example, the number of carbon atoms is 1 to 8; for example, an alkylene group such as a methylene group, an ethylene group, or a propylene group), substituted or unsubstituted divalent aromatic hydrocarbon groups (for example, the number of carbon atoms is 6 to 12; for example, a phenylene group), —O—, —S—, —SO2—, —N(R)— (R: alkyl group), —CO—, —NH—, —COO—, —CONH—, groups formed by combining the above-described groups (for example, an alkyleneoxy group, an alkyleneoxy carbonyl group, an alkylene carbonyl group, and the like), and the like.

In Formula (2) and Formula (3), m and n each is independently preferably 1 to 200 and more preferably 1 to 100.

In addition, the oxypropylene group (PO) may be any of a straight chain or a branch.

In the alkyl group represented by R¹ and R², the number of carbon atoms is preferably 1 to 10 and more preferably 1 to 5. Examples of the alkyl group represented by R¹ and R² include a methyl group and an ethyl group.

The compound having a siloxane structure may further have a structural unit other than the siloxane structural unit represented by Formula (1) to Formula (3), but the total content of the structural unit represented by Formula (1) to Formula (3) is preferably 50 mol % or more of the total structural units, more preferably 80 mol % or more of the total structural units, and still more preferably 90 mol % or more of the total structural units.

Specific examples of the compound having a siloxane structure that can be used in the present invention include BYK-333, BYK-307, BYK-302 (manufactured by BYK Japan KK), TEGOrad2100 (manufactured by Evonik), and the like.

In addition, a compound that is added as a levelling agent in the present invention, it is possible to use, in addition to the above-described compound having a siloxane structure, polyolefin compounds, fluorine-containing compounds, and the like. Examples thereof include MEGAFACE F781F (manufactured by DIC Corporation), POLYFLOW 75 (manufactured by Kyoeisha Chemical Co., Ltd.), and the like.

A content of the compound A in the composition for forming a transparent insulation layer is not particularly limited, but is preferably 0.001% to 10% by mass, more preferably 0.01% to 5% by mass, and particularly preferably 0.01% to 0.5% by mass of the total solid content amount.

In addition, the compound A may be used singly or two or more kinds of compounds A may be used in combination.

A content of the compound including a siloxane structure or other levelling agents in the composition for forming a transparent insulation layer is not particularly limited, but is preferably 0.001% to 10% by mass, more preferably 0.01% to 5% by mass, and particularly preferably 0.01% to 1% by mass of the total solid content amount.

In addition, the compound including a siloxane structure or other levelling agents may be used singly or two or more kinds of compounds or levelling agents may be used in combination.

(Polymerizable Compound Having (Meth)Acryloyl Group)

The composition for forming a transparent insulation layer preferably contains a polymerizable compound having a (meth)acryloyl group. However, the above-described compound A is not considered as the polymerizable compound having a (meth)acryloyl group.

The polymerizable compound (a polymerizable group-containing compound) is not particularly limited as long as the compound has an acryloyl group or a methacryloyl group as a polymerizable group and may be any form selected from a monomer, an oligomer, and a polymer. That is, the polymerizable compound may be a monomer having a polymerizable group, an oligomer having a polymerizable group, or a polymer having a polymerizable group.

Meanwhile, the monomer is preferably a compound having a molecular weight of less than 1,000.

In addition, the oligomer and the polymer are a polymer that is a combination of a limited number (generally 5 to 100) of monomers. The oligomer refers to a compound having a weight-average molecular weight of 3,000 or less, and the polymer refers to a compound having a weight-average molecular weight of more than 3,000.

One kind of the polymerizable compound may be used, or a plurality of kinds of the polymerizable compounds may be jointly used.

In addition, the polymerizable compound may be monofunctional or may be polyfunctional.

Examples of the monofunctional (meth)acrylate include long-chain alkyl (meth)acrylates such as butyl (meth)acrylate, amyl (meth)acrylate, 2-ethylhexyl (meth)acrylate, octyl (meth)acrylate, nonyl (meth)acrylate, dodecyl (meth)acrylate, lauryl (meth)acrylate, hexadecyl (meth)acrylate, and octadecyl (meth)acrylate, (meth)acrylates having a cyclic structure such as cyclohexyl (meth)acrylate, benzyl (meth)acrylate, phenoxyethyl (meth)acrylate, nonylphenoxyethyl (meth)acrylate, tetrahydrofurfuryl (meth)acrylate, nonylphenoxyethyl tetrahydrofurfuryl (meth)acrylate, caprolactone-modified tetrafurfuryl (meth)acrylate, dicyclopentanyl (meth)acrylate, dicyclopentenyl (meth)acrylate, dicyclopentenyloxyethyl (meth)acrylate, ethylene oxide-modified nonylphenol (meth)acrylate, propylene oxide-modified nonylphenol (meth)acrylate, and 2-ethylhexyl carbitol (meth)acrylate, glycidyl (meth)acrylate, methoxyethyl (meth)acrylate, butoxyethyl (meth)acrylate, 2-hydroxyethyl (meth)acrylate, 2-hydroxypropyl (meth)acrylate, 3-chloro-2-hydroxypropyl (meth)acrylate, dimethylaminoethyl (meth)acrylate, 2-(meth)acryloyloxyethyl acid phosphate, diethylaminoethyl (meth)acrylate, isomyristyl (meth)acrylate, isostearyl (meth)acrylate, 3-hydroxypropyl (meth)acrylate, 4-hydroxybutyl (meth)acrylate, isobornyl (meth)acrylate, esters of (meth)acrylic acid and a polyhydric alcohol, and the like.

Examples of difunctional (meth)acrylate include ethylene glycol di(meth)acrylate, diethylene glycol di(meth)acrylate, triethylene glycol di(meth)acrylate, tetraethylene glycol di(meth)acrylate, 1,4-butanediol di(meth)acrylate, 1,6-hexanediol di(meth)acrylate, 1,9-nonanediol di(meth)acrylate, glycerin di(meth)acrylate, neopentyl glycol di(meth)acrylate, 3-methyl-1,5 pentanediol di(meth)acrylate, 2-butyl-2-ethyl-1,3 propane di(meth)acrylate, dimethylol tricyclodecane di(meth)acylate, propylene glycol di(meth)acrylate, dipropylene glycol di(meth)acrylate, tripropylene glycol di(meth)acrylate, tetrapropylene glycol di(meth)acrylate, neopentyl glycol hydroxypivalate di(meth)acrylate, 1,3 butanediol di(meth)acrylate, dimethylol dicyclopentane diacrylate, hexamethylene glycol diacrylate, hexaethylene glycol di(meth)acrylate, polyethylene glycol di(meth)acrylate, polypropylene glycol di(meth)acrylate, butylene glycol di(meth)acrylate, 2,2′-bis(4-acryloxydiethoxyphenyl)propane, biphenol A tetraethylene glycol diacrylate, and the like.

Examples of trifunctional (meth)acrylate include trimethylolpropane tri(meth)acrylate, ethylene oxide-modified trimethylolpropane tri(meth)acrylate, propylene oxide-modified trimethylolpropane tri(meth)acrylate, tris(acryloxyethyl) isocyanurate, caprolactone-modified tris(acryloxyethyl) isocyanurate, pentaerythritol tri(meth)acrylate, dipentaerythritol tri(meth)acrylate, alkyl-modified dipentaerythritol tri(meth)acrylate, tetramethylolmethane tri(meth)acrylate, ethylene oxide-modified glycerol triacrylate, propylene oxide-modified glycerol triacrylate, ε caprolactone-modified trimethylolpropane triacrylate, pentaerythritol triacrylate, and the like.

Examples of tetrafunctional (meth)acrylate include ditrimethylolpropane tetra(meth)acrylate, pentaerythritol ethoxy tetra(meth)acrylate, and pentaerythritol tetra(meth)acrylate.

Examples of penta- or higher-functional (meth)acrylate compounds include dipentaerythritol penta(meth)acrylate, alkyl-modified dipentaerythritol penta(meth)acrylate, dipentaerythritol hexa(meth)acrylate, caprolactone-modified dipentaerythritol hexa(meth)acrylate, polypentaerythritol polyacrylate, and the like.

Furthermore, as described above, the polymerizable compound may be an oligomer or polymer having a (meth)acryloyl group. In addition, the number of polymerizable groups may be one or more, but is preferably two or more from the viewpoint of making the effects of the present invention superior.

An oligomer or polymer having a (meth)acryloyl group functions as a prepolymer. In other words, the oligomer or polymer can be polymerized with other monomers or polyfunctional compounds.

A method for manufacturing the prepolymer is not particularly limited, and examples thereof include a method in which the above-described monofunctional (meth)acrylate, a photopolymerization initiator or a thermopolymerization initiator, and a solvent are polymerized in a solution obtained by mixing them. A method for forming the prepolymer is preferably thermal polymerization.

Among polymerizable compounds having a (meth)acryloyl group, urethan (meth)acrylate compounds and epoxy (meth)acrylate compounds are preferred. From the viewpoint of the weather resistance, urethane (meth)acrylate compounds are more preferred. From the viewpoint of suppressing yellow discoloration, aliphatic urethane (meth)acrylate compounds are preferred.

Specifically, the urethane (meth)acrylate compound is preferably a compound that includes two or more photopolymerizable groups selected from the group consisting of an acryloyloxy group, an acryloyl group, a methacryloyloxy group, and a methacryloyl group in a molecule and includes one or more urethane bonds in a molecule. The above-described compound can be manufactured by, for example, a urethanization reaction between isocyanate and a hydroxyl group-containing (meth)acrylate compound. Meanwhile, the urethane (meth)acrylate compound may be a so-called oligomer or a polymer.

The photopolymerizable group is a polymerizable group that can be radical-polymerized. The polyfunctional urethane (meth)acrylate compound including two or more photopolymerizable groups in a molecule forms a transparent insulation layer having a high hardness and is thus useful.

The number of photopolymerizable groups in one molecule of the urethane (meth)acrylate compound is preferably at least two, for example, more preferably 2 to 10, and still more preferably 2 to 6. Meanwhile, two or more photopolymerizable groups included in the urethane (meth)acrylate compound may be the same as each other or different from each other.

Among these, the photopolymerizable group is preferably an acryloyloxy group or a methacryloyloxy group.

The number of urethane bonds included in a molecule of the urethane (meth)acrylate compound needs to be one or more and is preferably 2 or more and more preferably, for example, 2 to 5 since the hardness of a transparent insulation layer to be formed becomes higher.

Meanwhile, in the urethane (meth)acrylate compound including two urethane bonds in a molecule, the photopolymerizable groups may be bonded to only one urethane bond directly or through linking groups or may be bonded to two urethane bonds respectively directly or through linking groups.

In an aspect, one or more photopolymerizable groups are preferably bonded to each of the two urethane bonds that are bonded through linking groups.

As described above, in the urethane (meth)acrylate compound, the urethane bond and the photopolymerizable group may be bonded directly or a linking group may be present between the urethane bond and the photopolymerizable group. The linking group is not particularly limited, and linear or branched saturated or unsaturated hydrocarbon groups, cyclic groups, groups formed by combining two or more of the above-described groups, and the like can be exemplified. The number of carbon atoms in the hydrocarbon group is, for example, approximately 2 to 20, but is not particularly limited. In addition, examples of a cyclic structure included in the cyclic group include aliphatic rings (cyclohexane ring and the like), aromatic rings (benzene ring, naphthalene ring, and the like), and the like. The above-described groups may or may not have a substituent.

Meanwhile, in the present specification, unless particularly otherwise described, groups described may or may not have a substituent. In a case in which a given group has a substituent, as the substituent, an alkyl group (for example, an alkyl group having 1 to 6 carbon atoms), a hydroxy group, an alkoxyl group (for example, an alkoxyl group having 1 to 6 carbon atoms), a halogen atom (for example, a fluorine atom, a chlorine atom, or a bromine atom), a cyano group, an amino group, a nitro group, an acyl group, a carboxyl group, and the like can be exemplified.

The urethane (meth)acrylate compound can be synthesized using a well-known method. In addition, the urethane (meth)acrylate compound can also be procured from commercially available products.

Examples of a synthesis method include a method in which an alcohol, a polyol, and/or a hydroxy group-containing compound such as hydroxy group-containing (meth)acrylate and isocyanate are reacted with one another. In addition, a method in which a urethane compound obtained by the above-described reaction is esterified with (meth)acrylic acid as necessary can be exemplified. Meanwhile, the expression “(meth)acrylic acid” is used to indicate both acrylic acid and methacrylic acid.

As the isocyanate, for example, aromatic, aliphatic, and alicyclic polyisocyanates are exemplified, and examples thereof include tolylene diisocyanate, diphenylmethane diisocyanate, hydrogenated diphenylmethane diisocyanate, polyphenylmethane polyisocyanate, modified diphenylmethane diisocyanate, hydrogenated xylylene diisocyanate, xylylene diisocyanate, hexamethylene diisocyanate, trimethylhexamethylene diisocyanate, tetramethylxylylene diisocyanate, isophorone diisocyanate, norbornene diisocyanate, 1,3-bis(isocyanatomethyl) cyclohexane, phenylene diisocyanate, lysine diisocyanate, lysine triisocyanate, naphthalene diisocyanate, and the like. One kind of isocyanate may be used or two or more kinds of isocyanates may be jointly used.

Examples of the hydroxy group-containing (meth)acrylate include 2-hydroxyethyl acrylate, 2-hydroxypropyl acrylate, 2-hydroxybutyl acrylate, 4-hydroxybutyl acrylate, 2-hydroxyethyl acryloyl phosphate, 2-acryloyloxyethyl-2-hydroxypropyl phthalate, glycerin diacrylate, 2-hydroxy-3-acryloyloxypropyl acrylate, pentaerythritol triacrylate, dipentaerythritol pentaacrylate, caprolactone-modified 2-hydroxyethyl acrylate, cyclohexane dimethanol monoacrylate, and the like. One kind of hydroxy group-containing (meth)acrylate may be used or two or more kinds of hydroxy group-containing (meth)acrylates may be jointly used.

Commercially available products of the urethane (meth)acrylate compound are not limited to the following products, but examples thereof can include UA-306H, UA-3061, UA-306T, UA-510H, UF-8001G, UA-101I, UA-101T, AT-600, AH-600, and AI-600 manufactured by Kyoei Kagaku Kogyo, U-4HA, U-6HA, U-6LPA, UA-32P, U-15HA, and UA-1100H manufactured by Shin-Nakamura Chemical Co., Ltd., SHIKOH UV-1400B, SHIKOH UV-1700B, SHIKOH UV-6300B, SHIKOH UV-7550B, SHIKOH UV-7600B, SHIKOH UV-7605B, SHIKOH UV-7610B, SHIKOH UV-7620EA, SHIKOH UV-7630B, SHIKOH UV-7640B, SHIKOH UV-6630B, SHIKOH UV-7000B, SHIKOH UV-7510B, SHIKOH UV-7461TE, SHIKOH UV-3000B, SHIKOH UV-3200B, SHIKOH UV-3210EA, SHIKOH UV-3310EA, SHIKOH UV-3310B, SHIKOH UV-3500BA, SHIKOH UV-3520TL, SHIKOH UV-3700B, SHIKOH UV-6100B, SHIKOH UV-6640B, SHIKOH UV-2000B, SHIKOH UV-2010B, and SHIKOH UV-2250EA manufactured by The Nippon synthetic Chemical Industry Co., Ltd. In addition, SHIKOH UV-2750B manufactured by The Nippon synthetic Chemical Industry Co., Ltd., UL-503LN manufactured by Kyoei Kagaku Kogyo, UNIDIC 17-806, UNIDIC 17-813, UNIDIC V-4030, and UNIDIC V-4000BA manufactured by DIC Corporation, EB-1290K manufactured by Daicel UCB Co., Ltd., HIGH-COAP AU-2010 and HIGH-COAP AU-2020 manufactured by Tokushiki Co., Ltd., and the like.

Examples of hexa- or high-functional urethane (meth)acrylate compound can include ART RESIN UN-3320HA, ART RESIN UN-3320HC. ART RESIN UN-3320HS, and ART RESIN UN-904 manufactured by Negami Chemical Industrial Co., Ltd., SHIKOH UV-1700B, SHIKOH UV-7605B, SHIKOH UV-7610B, SHIKOH UV-7630B, and SHIKOH UV-7640B manufactured by The Nippon synthetic Chemical Industry Co., Ltd., NK OLIGO U-6PA, NK OLIGO U-10HA, NK OLIGO U-10PA, NK OLIGO U-1100H, NK OLIGO U-15HA, NK OLIGO U-53H, and NK OLIGO U-33H manufactured by Shin-Nakamura Chemical Co., Ltd., KRM8452, EBECRYL1290, KRM8200, EBECRYL5129, and KRM8904 manufactured by Daicel-Allnex Ltd., UX-5000 manufactured by Nippon Kayaku Co., Ltd., and the like.

In addition, as di to trifunctional urethane (meth)acrylate compound, NATOCO UV SELF-HEALING manufactured by Natoco Co., Ltd., EXP DX-40 manufactured by DIC Corporation, and the like can also be exemplified.

A molecular weight (weight-average molecular weight Mw) of the urethane (meth)acrylate compound is preferably in a range of 300 to 10,000. In a case in which the molecular weight is in this range, it is possible to obtain a transparent insulation layer having an excellent flexibility and an excellent surface hardness.

In addition, the epoxy (meth)acrylate compound refers to a compound obtained by an addition reaction between polyglycidyl ether and (meth)acrylic acid and has at least two (meth)acryloyl groups in the molecule in many cases.

From the viewpoint of the solvent resistance, the adhesiveness, the levelability, or the hardness, the polymerizable compound having a (meth)acryloyl group preferably includes at least an urethane (meth)acrylate compound or an epoxy (meth)acrylate compound and a di- or higher-functional (meth)acrylate monomer (here, the above-described urethane (meth)acrylate compound or epoxy (meth)acrylate compound is not considered as the di- or higher-functional (meth)acrylate monomer) as a polyfunctional compound and also preferably further includes a monofunctional (meth)acrylate monomer as a dilutional monomer. Meanwhile, the solvent resistance mentioned herein refers to a property of the polymerizable compound that does not change properties (becomes white) in a case in which a solvent is attached thereto. The solvent resistance is assumed to be a characteristic in which a polymer component in the transparent insulation layer is diverted due to the expansion of the solvent and a phenomenon causing the denaturation of film qualities is suppressed.

A total content of the urethane (meth)acrylate compound and the epoxy (meth)acrylate compound in the composition for forming a transparent insulation layer is not particularly limited, but is preferably 10 to 70% by mass and more preferably 30 to 65% by mass of the total solid content of the composition for forming a transparent insulation layer since the effect of the present invention is superior.

The urethane (meth)acrylate compound or epoxy (meth)acrylate compound can be used singly or two or more urethane (meth)acrylate compounds or epoxy (meth)acrylate compounds can be used in combination. Meanwhile, in the case of including two or more urethane (meth)acrylate compounds or epoxy (meth)acrylate compounds, the total amount is preferably in the above-described range.

The content of the di- or higher-functional (meth)acrylate monomer with respect to the total mass of the polymerizable compound is not particularly limited, but is preferably 0% to 50% by mass and more preferably 20% to 45% by mass.

Among the above-described polyfunctional compounds, pentaerythritol tri(meth)acrylate, pentaerythritol tetra(meth)acrylate, dipentaerythritol hexa(meth)acrylate, dipentaerythritol penta(meth)acrylate, and mixtures thereof are preferred from the viewpoint of the abrasion resistance.

The polyfunctional compounds can be used singly or two or more polyfunctional compounds can be used in combination.

In a case in which the polymerizable compound contains a monofunctional monomer as a dilutional monomer, a content of the monofunctional monomer with respect to the total mass of the polymerizable compound is not particularly limited, but is preferably small, more preferably 40% by mass or less, and still more preferably 10% by mass or less.

Among the above-described dilutional monomers, from the viewpoint of the adhesiveness or the curing rate, long-chain alkyl (meth)acrylates or (meth)acrylates having a cyclic structure are preferred, among them, long-chain alkyl (meth)acrylates such as lauryl (meth)acrylate or hexadecyl (meth)acrylate and (meth)acrylates having a cyclic structure such as isobornyl (meth)acrylate, dicyclopentanyl (meth)acrylate, and dicyclopentenyl (meth)acrylate are more preferred.

The dilutional monomers can be used singly or two or more dilutional monomers can be used in combination.

(Polymerization Initiator)

The composition for forming a transparent insulation layer preferably includes a polymerization initiator. The polymerization initiator may be any of a photopolymerization initiator and a thermopolymerization initiator, but is preferably a photopolymerization initiator.

The kind of the photopolymerization initiator is not particularly limited, and well-known photopolymerization initiators (radical photopolymerization initiators and cationic photopolymerization initiators) can be used. Examples thereof include carbonyl compounds such as acetophenone, 2,2-diethoxyacetophenone, p-methylacetophenone, p-dimethylaminopropiophenone, benzophenone, 2-chlorobenzophenone, benzyl, benzoin, benzoin methyl ether, benzoin ethyl ether, benzoin isopropyl ether, 2,2-dimethoxy-1,2-diphenyl ethane-1-one, 1-cyclohexyl phenyl ketone, 1-hydroxy-cyclohexyl phenyl ketone, 2-hydroxy-2-methyl-1-phenylpropane-1-one, 1-[4-(2-hydroxyethoxy)-phenyl]-2-hydroxy-2-methyl-1-propane-1-one, oligo(2-hydroxy-2-methyl-1-(4-(1-methylvinyl)phenyl)propanone), 2-hydroxy-1-{4-[4-(2-hydroxy-2-methyl-propionyl)-benzyl]-phenyl}-2-methylpropane-1-one, 2-methyl-1-[4-(methylthio)phenyl]-2-morpholinopropane-1-one, 2-benzyl-2-dimethylamino-1-(4-morpholinophenyl)-butanone-1, bis(2,4,6-trimethylbenzoyl)-phenylphosphine oxide, 2,4,6-trimethylbenzoyl-diphenylphosphine oxide, bis(2,6-dimethoxybenzoyl)-2,4,4-trimethyl-pentylphosphine oxide, ethyl-(2,4,6-trimethylbenzoyl)phenylphosphinate, 1,2-octanedione, 1-[4-(phenylthio)-2-(O-benzoyloxime)], methylbenzoyl formate, 4-methylbenzophenone, 4-phenylbenzophenone, 2,4,6-trimethylbenzophenone, 4-benzoyl-4′-methyldiphenyl sulfide, and 1-[4-(4-benzoylphenylsulfanyl)phenyl]-2-methyl-2-(4-methylphenylsulfonyl)propane-1-one, sulfur compounds such as thioxanthone, 2-chlorothioxanthone, 2-methylthioxanthone, tetramethylthiuram disulfide, and the like.

One kind of polymerization initiator can be used singly or two or more kinds of polymerization initiators can be used in combination.

A content of the polymerization initiator in the composition for forming a transparent insulation layer is not particularly limited, but is preferably 0.1 to 10% by mass and more preferably 2 to 5% by mass of the total mass of the composition from the viewpoint of the curing property of the transparent insulation layer. Meanwhile, in a case in which two or more kinds of polymerization initiators are used, the total content of the polymerization initiators is preferably in the above-described range.

(Other Additives)

To the composition for forming a transparent insulation layer, in addition to the above-described components, a variety of well-known additives of the related art such as a surface lubricant, an antioxidant, a corrosion inhibitor, a light stabilizer, an ultraviolet absorbent, a polymerization inhibitor, a silane coupling agent, an inorganic or organic filler, powder such as metal powder and a pigment, and a particle-like or foil-like substance can be appropriately added depending on the intended use. Regarding the details thereof, it is possible to refer to, for example, Paragraphs 0032 to 0034 of JP2012-229412A. However, the additives are not limited thereto, and a variety of additives that can be generally used for photopolymerizable compositions can be used. In addition, an amount of the additives added to the composition may be appropriately adjusted and is not particularly limited.

<Method for Forming Transparent Insulation Layer>

The composition for forming a transparent insulation layer capable of forming the transparent insulation layer preferably includes, in addition to the compound A, at least the polymerizable compound having a (meth)acryloyl group and the photopolymerization initiator.

In addition, the composition for forming a transparent insulation layer may include a solvent from the viewpoint of handleability, but the composition for forming a transparent insulation layer preferably includes no solvent from the viewpoint of suppressing volatile organic compounds (VOC) and the viewpoint of decreasing the tack time. The composition for forming a transparent insulation layer is excellent in terms of the compatibility with the polymerizable compound having a (meth)acryloyl group and the photopolymerization initiator due to a hydrophobic polyoxypropylene chain included in the compound A even in the case of not including any solvents.

Meanwhile, in a case in which the composition for forming a transparent insulation layer contains a solvent, solvents that can be used are not particularly limited, and examples thereof include water and organic solvents.

In the case of the coating method, a method for applying the composition for forming a transparent insulation layer onto the base material and the conductive portion is not particularly limited, and well-known methods (for example, a coating method such as a gravure coater, a comma coater, a bar coater, a knife coater, a die coater, or a roll coater, an ink jet method, a screen printing method, and the like) can be used. Particularly, in the case of using the screen printing method, the effects of the present invention can be further benefited. Compared to bar coating and the like, in the screen printing method, in principle, protrusions and recesses are formed on the surface of the coated film during printing. According to the composition for forming a transparent insulation layer containing the compound A, coated films having a high levelability ca be formed even in the case of using the screen printing method.

In addition, from the viewpoint of further improving the wettability to the base material and the conductive portion and making the effects of the present invention superior, a surface tension of the composition for forming a transparent insulation layer is preferably 35 mN/m or less and more preferably 30 mN/m or less at 25° C. The lower limit is not particularly limited, but is preferably 15 mN/m or more.

From the viewpoint of the handleability and the manufacturing efficiency, an aspect in which the composition is applied onto the base material and the conductive portion, and a drying treatment is carried out as necessary to remove the remaining solvent, thereby forming a coated film is preferred.

Meanwhile, conditions of the drying treatment are not particularly limited; however, from the viewpoint of superior productivity, the drying treatment is preferably carried out at room temperature to 220° C. (preferably 50° C. to 120° C.) for 1 to 30 minutes (preferably 1 to 10 minutes). From the viewpoint of the productivity, a status in which the composition for forming a transparent insulation layer does not include any solvent component and the drying treatment is not provided is preferred.

After the drying treatment, exposure is preferably carried out.

An exposure method is not particularly limited, and examples thereof include a method in which the coated film is irradiated with an active light ray or a radiant ray. In the irradiation with an active light ray, an ultraviolet (UV) lamp, light irradiation with a visible light or the like, or the like is used. Examples of a light source include a mercury lamp, a metal halide lamp, a xenon lamp, a chemical lamp, a carbon arc lamp, and the like. In addition, as the radiant ray, an electron beam, an X-ray, an ion beam, a far-infrared ray, and the like are exemplified. In the case of exposing the coated film, the polymerizable group included in the compound in the coated film is activated, crosslinking is formed between compounds, and the curing of the layer proceeds. An exposure energy needs to be approximately 10 to 8,000 mJ/cm² and preferably in a range of 50 to 3,000 mJ/cm².

The first embodiment of the conductive sheet for a touch sensor has been described in detail in FIG. 1, but a constitution of the conductive sheet for a touch sensor is not limited to this aspect.

In FIG. 1, the conductive sheet for a touch sensor having the conductive portion 16 disposed on only one surface of the base material 12 has been described, but the conductive sheet for a touch sensor of the embodiment of the present invention may have the conductive portions 16 and the transparent insulation layers 18 disposed on both surfaces of the base material 12.

[Touch Sensor, Touch Panel Laminate, and Touch Panel]

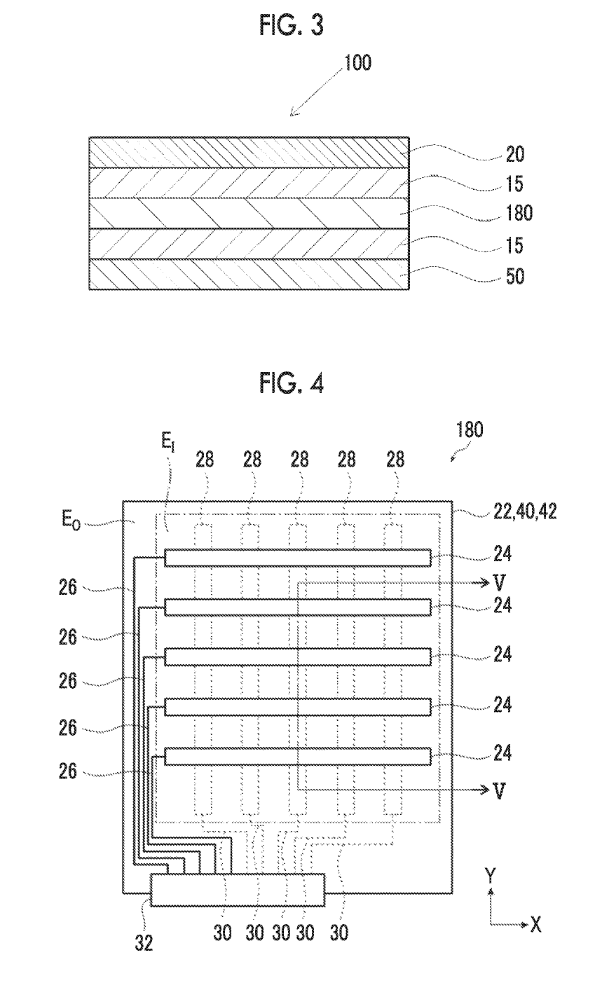

In addition, the conductive sheet for a touch sensor is applied to touch panels. In the case of applying the conductive sheet for a touch sensor to a touch panel, the conductive sheet for a touch sensor functions as a part of a touch sensor. As a preferred aspect of a touch panel including the conductive sheet for a touch sensor, an electrostatic capacitance-type touch panel illustrated in FIG. 3 is exemplified. An electrostatic capacitance-type touch panel 100 illustrated in FIG. 3 includes a protective substrate 20, a pressure-sensitive adhesive sheet 15, an electrostatic capacitance-type touch sensor 180, a pressure-sensitive adhesive sheet 15, and a display device 50. As described below, the electrostatic capacitance-type touch sensor 180 is constituted of the conductive sheet for a touch sensor of the embodiment of the present invention, and the conductive portion functions as a detection electrode.

Hereinafter, a variety of members that are used in the electrostatic capacitance-type touch panel 100 will be described in detail.

Meanwhile, in the following description, the electrostatic capacitance-type touch panel will be described, but the conductive sheet for a touch sensor of the embodiment of the present invention may also be applied to other forms of touch panels.

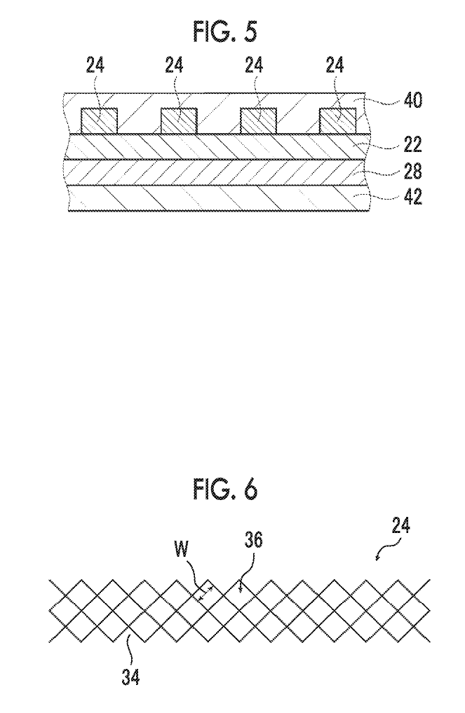

FIG. 4 illustrates a plan view of the electrostatic capacitance-type touch sensor 180. FIG. 5 is a cross-sectional view cut along a cutting line V-V illustrated in FIG. 4. The electrostatic capacitance-type touch sensor 180 comprises the base material 22, first detection electrodes 24 disposed on one main surface (on a front surface) of the base material 22, first drawing wires 26, second detection electrodes 28 disposed on the other main surface (on a rear surface) of the base material 22, second drawing wires 30, a flexible printed wiring board 32, a first transparent insulation layer 40 disposed so as to cover the first detection electrodes 24 and the first drawing wires 26, and a second transparent insulation layer 42 disposed so as to cover the second detection electrodes 28 and the second drawing wires 30.

Meanwhile, regions in which the first detection electrodes 24 and the second detection electrodes 28 constitute an input region E_{I} (an input region capable of detecting the contact of an article (sensing portion)) in which an input operation can be carried out by a user, and, in an outside region E_{O} located outside the input region E_{I}, the first drawing wires 26, the second drawing wires 30, and the flexible printed wiring board 32 are disposed. Meanwhile, the base material 22 of the electrostatic capacitance-type touch sensor 180 corresponds to the base material of the conductive sheet for a touch sensor, the first detection electrodes 24 and the second detection electrodes 28 of the electrostatic capacitance-type touch sensor 180 correspond to the conductive portion of the conductive sheet for a touch sensor, and the first transparent insulation layer 40 and the second transparent insulation layer 42 of the electrostatic capacitance-type touch sensor 180 correspond to the transparent insulation layer of the conductive sheet for a touch sensor.

Hereinafter, the above-described constitution will be described in detail.

The base material 22 is a member that plays a role of supporting the first detection electrodes 24 and the second detection electrodes 28 in the input region E_{I} and plays a role of supporting the first drawing wires 26 and the second drawing wires 30 in the outside region E_{O}.

The definition and the preferred aspect of the base material 22 are the same as those of the base material 12.

The first detection electrodes 24 and the second detection electrodes 28 are sensing electrodes that detect a change in the electrostatic capacitance and constitute a sensing portion (sensor portion). That is, in a case in which a fingertip comes into contact with a touch panel, the mutual electrostatic capacitance between the first detection electrode 24 and the second detection electrode 28 changes, and the location of the fingertip is computed using an IC circuit (integrated circuit) on the basis of this change amount.

The first detection electrode 24 plays a role of detecting an input location in an X direction of a user's finger that has come close to the input region E_{I} and has a function of generating an electrostatic capacitance between the finger and the first detection electrode.

The first detection electrodes 24 are electrodes that extend in a first direction (X direction) and are arrayed in a second direction (Y direction) orthogonal to the first direction at predetermined intervals and have a predetermined pattern as described below.

The second detection electrode 28 plays a role of detecting an input location in a Y direction of the user's finger that has come close to the input region E_{I} and has a function of generating an electrostatic capacitance between the finger and the second detection electrode. The second detection electrodes 28 are electrodes that extend in the second direction (Y direction) and are arrayed in the first direction (X direction) at predetermined intervals and have a predetermined pattern as described below. In FIG. 4, the number of the first detection electrodes 24 provided is five, and the number of the second detection electrodes 28 provided is also five, but the numbers are not particularly limited, but need to be plural.

In FIG. 4, the first detection electrodes 24 and the second detection electrodes 28 are constituted of fine metal wires. FIG. 6 is an enlarged plan view of a part of the first detection electrode 24. As illustrated in FIG. 6, the first detection electrode 24 is constituted of the fine metal wires 34 and includes a plurality of opening portions 36 formed by the intersecting fine metal wires 34. Meanwhile, the second detection electrode 28 also, similar to the first detection electrode 24, includes a plurality of opening portions 36 formed by the intersecting fine metal wires 34. That is, the first detection electrodes 24 and the second detection electrodes 28 correspond to the conductive portion having a mesh pattern formed of a plurality of the above-described fine metal wires.

The first detection electrodes 24 and the second detection electrodes 28 correspond to the above-described conductive portion 16 and has a mesh pattern formed of a plurality of fine metal wires. The definition and the preferred aspect of the fine metal wires 34 constituting the first detection electrodes 24 and the second detection electrodes 28 are the same as those of the fine metal wire 14. In addition, the definition of an opening portion 36 is also as described above.

Each of the first drawing wires 26 and the second drawing wires 30 is a member playing a role of applying voltage to the first detection electrodes 24 and the second detection electrodes 28.

The first drawing wires 26 are disposed on the base material 22 in the outside region E_{O}, and one end of the first drawing wire is electrically connected to the corresponding first detection electrode 24, and the other end thereof is electrically connected to a flexible printed wiring board 32.

The second drawing wires 30 are disposed on the base material 22 in the outside region E_{O}, and one end of the second drawing wire is electrically connected to the corresponding second detection electrode 28, and the other end thereof is electrically connected to a flexible printed wiring board 32.

Meanwhile, In FIG. 4, the number of the first drawing wires 26 illustrated is five, and the number of the second drawing wires 30 illustrated is also five, but the numbers are not particularly limited, and, generally, a plurality of drawing wires is disposed depending on the number of the detection electrodes.

Examples of a material constituting the first drawing wires 26 and the second drawing wires 30 include metal such as gold (Au), silver (Ag), or copper (Cu), metallic oxides such as tin oxide, cadmium oxide, potassium oxide, and titanium oxide, and the like. Among these, silver is preferred for the reason of the excellent conductive property. In addition, the drawing wires may be produce using metal paste such as silver paste or copper paste. Furthermore, the drawing wires may be constituted of metal such as aluminum (Al) or molybdenum (Mo) or an alloy thin film. A patterning method that is preferably used is the screen printing or ink jet printing method in the case of metal paste and a photolithography method of a sputtered film in the case of metal or an alloy thin film.

Meanwhile, the first drawing wires 26 and the second drawing wires 30 preferably includes a binder from the viewpoint of the adhesiveness between to the base material 22. The kind of the binder is as described above.

The flexible printed wiring board 32 is a board having a plurality of wires and terminals provided on a substrate, is connected to the other ends of the respective first drawing wires 26 and the other ends of the respective second drawing wires 30, and plays a role of connecting the electrostatic capacitance-type touch sensor 180 and an external device (for example, a display device).

The first transparent insulation layer 40 is a layer disposed on the base material 22 so as to cover the first detection electrodes 24 and the first drawing wires 26. In addition, the second transparent insulation layer 42 is a layer disposed on the base material 22 so as to cover the second detection electrodes 28 and the second drawing wires 30.

The preferred aspects of the first transparent insulation layer 40 and the second transparent insulation layer 42 are the same as those of the transparent insulation layer.

Meanwhile, the first transparent insulation layer 40 and the second transparent insulation layer 42 are disposed on the base material 22 in a region other than a region in which the above-described flexible printed wiring board 32 is disposed.

[Method for Manufacturing Electrostatic Capacitance-Type Touch Sensor]

A method for manufacturing the electrostatic capacitance-type touch sensor 180 is not particularly limited, and a well-known method can be employed.

First, as a method for forming the detection electrodes and the drawing wires on the base material, for example, a method in which photoresist films on metal foils formed on both main surfaces of the base material are exposed and developed to form resist patterns, and the metal foils exposed through the resist patterns are etched is exemplified. In addition, a method in which paste including fine metal particles or metal nanowires is printed on both main surfaces of the base material and metal plating is carried out on the paste is exemplified.

Furthermore, in addition to the above-described methods, a method in which silver halide is used is exemplified. More specifically, a method described in Paragraphs 0056 to 0114 of JP2014-209332A is exemplified.

With the above-described sequence, the base material having a pattern-like conductive portion made of a fine metal wire is manufactured. Next, the transparent insulation layer is disposed so as to cover the obtained conductive portion.

As a method for forming the transparent insulation layer, the above-described method in which the composition for forming a transparent insulation layer is used is exemplified.

<<Pressure-Sensitive Adhesive Sheet>>

The pressure-sensitive adhesive sheet (pressure-sensitive adhesive layer) 15 is disposed in order to attach the electrostatic capacitance-type touch sensor 180 and the protective substrate 20 or the display device 50. The pressure-sensitive adhesive sheet (pressure-sensitive adhesive layer) 15 is not particularly limited, and well-known pressure-sensitive adhesive sheets can be used.

<<Protective Substrate>>

The protective substrate 20 is a substrate disposed on the pressure-sensitive adhesive sheet 15 and plays a role of protecting an electrostatic capacitance-type touch sensor 180 described below from the outside environment, and a main surface thereof constitutes a touch surface.

The protective substrate 20 is preferably a transparent substrate, and a plastic film, a plastic plate, a glass plate, or the like is used. A thickness of the substrate is desirably appropriately selected depending on individual uses.

As a raw material of the plastic film and the plastic plate, for example, polyesters such as polyethylene terephthalate (PET) and polyethylene naphthalate (PEN); polyolefins such as polyethylene (PE), polypropylene (PP), polystyrene, and polyethylene vinyl acetate copolymer (EVA); vinyl-based resins; additionally, polycarbonate (PC), polyamide, polyimide, acryloyl resins, triacetyl cellulose (TAC), cycloolefin-based resins (COP), and the like can be used.

In addition, as the protective substrate 20, a polarizing plate, a circularly polarizing plate, or the like may also be used.

<<Display Device>>

The display device 50 is a device having a display surface that displays images, and the respective members are disposed on a display screen side.

The kind of the display device 50 is not particularly limited, and well-known display devices can be used. Examples thereof include a cathode ray tube (CRT) display device, a liquid crystal display device (LCD), an organic light-emitting diode (OLED) display device, a vacuum fluorescent display (VFD), a plasma display panel (PDP), a surface electric field display (SED), a field emission display (FED), electronic paper (E-paper), and the like.

Hitherto, an example of the touch panel in which the conductive sheet for a touch sensor of the embodiment of the present invention is caused to function as a part of the touch sensor has been described, but the conductive sheet for a touch sensor of the embodiment of the present invention may also be constituted as a touch panel laminate. Examples of the touch panel laminate include constitutions including a conductive sheet for a touch sensor, a pressure-sensitive adhesive sheet, and a peeling sheet. The peeling sheet functions as a protective sheet for preventing the conductive sheet for a touch sensor from being damaged while the touch panel laminate is transported.

In addition, the conductive sheet for a touch sensor of the embodiment of the present invention may also be handled in a form of, for example, a complex having a conductive sheet for a touch sensor, a pressure-sensitive adhesive sheet, and a protective substrate in this order.

[Composition for Forming Transparent Insulation Layer]

The composition for forming a transparent insulation layer of the embodiment of the present invention is a composition for forming a transparent insulation layer that is used to manufacture conductive sheets for a touch sensor and is applied to the surface of the pattern-like conductive portion made of a fine metal wire and includes the compound A.

The constitution of the composition for forming a transparent insulation layer of the embodiment of the present invention is the same as the constitution of the composition for forming a transparent insulation layer described in the section of the constitution of the conductive sheet for a touch sensor, and a preferred aspect thereof is also identical.

### EXAMPLES

Hereinafter, the present invention will be described in more detail on the basis of examples. Materials, amounts used, proportions, treatment contents, treatment orders, and the like described in the following examples can be appropriately modified within the scope of the gist of the present invention. Therefore, the scope of the present invention is not supposed to be restrictively interpreted by the examples described below.

### Example 1

<<Production of Conductive Sheet for Touch Sensor>>

<Formation of Conductive Portion>

(Preparation of Silver Halide Emulsion)

90% of a liquid 2 described below and 90% of a liquid 3 described below were added at the same time to a liquid 1 described below held at 38° C. and a pH of 4.5 for 20 minutes under stirring, thereby forming 0.16 μm nucleus particles. Subsequently, a liquid 4 described below and a liquid 5 described below were added thereto for eight minutes, and, furthermore, the remaining 10% of the liquid 2 described below and the remaining 10% of the liquid 3 described below were added thereto for two minutes, thereby causing the particles to grow up to 0.21 μm. Furthermore, 0.15 g of potassium iodide was added thereto, the particles were aged for five minutes, and the formation of the particles was finished.

| Liquid 1: | | |
|---|---|---|
| Water | 750 | ml |
| Gelatin | 8.6 | g |
| Sodium chloride | 3 | g |
| 1,3-dimethylimidazolidine-2-thione | 20 | mg |
| Sodium benzene thiosulfonate | 10 | mg |
| Citric acid | 0.7 | g |
| Liquid 2: | | |
| Water | 300 | ml |
| Silver nitrate | 150 | g |
| Liquid 3: | | |
| Water | 300 | ml |
| Sodium chloride | 38 | g |
| Potassium bromide | 32 | g |
| Potassium hexachloroiridate (III) | 5 | ml |
| (0.005% KCl 20% aqueous solution) | | |
| Ammonium hexachlororhodiumate | 7 | ml |
| (0.001% NaCl 20% aqueous solution) | | |
| Liquid 4: | | |
| Water | 100 | ml |
| Silver nitrate | 50 | g |
| Liquid 5: | | |
| Water | 100 | ml |
| Sodium chloride | 13 | g |
| Potassium bromide | 11 | g |
| Yellow prussiate of potash | 5 | mg |

After that, the particles were pickled using a flocculation method according to a normal method. Specifically, a temperature of a solution obtained above was decreased to 35° C. and a pH was decreased using sulfuric acid until silver halide settled (the pH was in a range of 3.6±0.2). Next, approximately 3 liters of a supernatant liquid was removed (first pickling). Furthermore, 3 liters of distilled water was added thereto, and thus sulfuric acid was added thereto until silver halide settled. Again, approximately 3 liters of a supernatant liquid was removed (second pickling). The same operation as the second pickling was further repeated once (third pickling), and a pickling and desalination step was finished. A pickled and desalinated emulsion was adjusted to a pH of 6.4 and a pAg of 7.5, 2.5 g of gelatin, 10 mg of sodium benzene thiosulfonate, 3 mg of sodium benzene thiosulfinate, 15 mg of sodium thiosulfate, and 10 mg of chlorauric acid were added thereto, and chemical sensitization was carried out so as to obtain the optimal sensitivity at 55° C. After that, furthermore, 100 mg of 1,3,3a,7-tetraazaindene as a stabilizer and 100 mg of PROXEL (trade name, manufactured by ICI Co., Ltd.) as a preservative were added thereto. A finally-obtained emulsion was a silver iodochlorobromide cubic particle emulsion which included 0.08 mol % of silver iodide, has a ratio between silver chloride and silver bromide in silver chlorobromide of 70 mol % and 30 mol %, an average particle diameter of 0.22 μm and a coefficient of variation of 9%.

(Preparation of Composition for Forming Photosensitive Layer)

1.2×10⁻⁴ mol/mol Ag of 1,3,3a,7-tetraazaindene, 1.2×10⁻² mol/mol Ag of hydroquinone, 3.0×10⁻⁴ mol/mol Ag of citric acid, 0.90 g/mol Ag of 2,4-dichloro-6-hydroxy-1,3,5-triazine sodium salt, and a small amount of a hardener were added to the above-described emulsion, and a pH of a coating fluid was adjusted to 5.6 using citric acid.

In the above-described coating fluid, a polymer latex containing a polymer represented by Formula (P-1) and a dispersant made of dialkyl phenyl polyethylene glycol (PEO) sulfuric acid ester (a mass ratio of the dispersant to the polymer was 2.0/100=0.02) was added to the gelatin contained in the coating fluid so that a mass ratio of the polymer to the gelatin reached 0.5/1.

Furthermore, EPOXY RESIN DY 022 (trade name, manufactured by Nagase ChemteX Corporation) was added thereto as a crosslinking agent. Meanwhile, an amount of the crosslinking agent added was adjusted so that an amount of the crosslinking agent in a silver halide-containing photosensitive layer described below reached 0.09 g/m².

A composition for forming a photosensitive layer was prepared as described above.

Meanwhile, the polymer represented by Formula (P-1) was synthesized with reference to JP3305459B and JP3754745B.

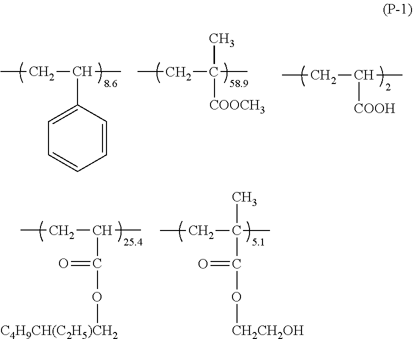

(Photosensitive Layer-Forming Step)

The above-described polymer latex was applied onto a 100 μm-thick polyethylene terephthalate (PET) film, thereby providing a 0.05 μm-thick undercoat layer.

Next, a silver halide-free composition for forming a layer in which the polymer latex and gelatin were mixed together was applied onto the undercoat layer, thereby providing a 1.0 μm-thick silver halide-free layer. Meanwhile, a mixing mass ratio (polymer/gelatin) of the polymer to gelatin was 2/1, and a content of the polymer was 0.65 g/m².

Next, the composition for forming a photosensitive layer was applied onto the silver halide-free layer, thereby providing a 2.5 μm-thick silver halide-containing photosensitive layer. Meanwhile, a mixing mass ratio (polymer/gelatin) of the polymer to gelatin in the silver halide-containing photosensitive layer was 0.5/1, and a content of the polymer was 0.22 g/m².

Next, a composition for forming a protective layer in which the polymer latex and gelatin were mixed together was applied onto the silver halide-containing photosensitive layer, thereby providing a 0.15 μm-thick protective layer. Meanwhile, a mixing mass ratio (polymer/gelatin) of the polymer to gelatin was 0.1/1, and a content of the polymer was 0.015 g/m².

(Exposure and Development Treatment)

The photosensitive layer produced above was exposed using parallel light coming from a high-pressure mercury lamp as a light source through a photomask capable of imparting a developed silver image having a mesh pattern illustrated in FIG. 2. Specifically, the thickness of the conductive portion was 1 μm, and a grid (square)-like photomask that imparted a conductive pattern in which a fine conductive wire was 4 μm and a non-conductive portion was 300 μm was used. After the exposure, the photosensitive layer was developed with a developer described below, furthermore, subjected to a development treatment using a fixer (trade name: N3X-R for CN16X, manufactured by Fujifilm Corporation), rinsed with pure water, and then dried.

(Composition of Developer)

1 liter (L) of the developer included compounds described below.

| | |
|---|---|
| Hydroquinone | 0.037 mol/L |
| N-methylaminophenol | 0.016 mol/L |
| Sodium metaborate | 0.140 mol/L |
| Sodium hydroxide | 0.360 mol/L |
| Sodium bromide | 0.031 mol/L |
| Potassium metabisulfite | 0.187 mol/L |

(Heating Treatment)

Furthermore, the photosensitive layer was left to stand in an overheated steam vessel (120° C.) for 130 seconds, thereby carrying out a heating treatment.

(Gelatin Decomposition Treatment)

Furthermore, the photosensitive layer was immersed in a gelatin decomposition fluid (40° C.) prepared as described below for 120 seconds and then immersed in warm water (liquid temperature: 50° C.) for 120 seconds, thereby washing the photosensitive layer.

Preparation of Gelatin Decomposition Fluid:

Triethanolamine and sulfuric acid were added to an aqueous solution of a protein degrading enzyme (BIOPLASE 30L manufactured by Nagase ChemteX Corporation) (a concentration of the protein degrading enzyme: 0.5% by mass), and a pH was adjusted to 8.5.

(Polymer Crosslinking Treatment)

Furthermore, the photosensitive layer was immersed in a 1% aqueous solution of CARBODILITE V-02-L2 (trade name: manufactured by Nisshinbo Chemical Inc.) for 30 seconds, removed from the aqueous solution, immersed in pure water (at room temperature) for 60 seconds, and washed.

A film A in which a conductive portion was formed on the PET film was obtained in the above-described manner.

<Formation of Transparent Insulation Layer>

A liquid mixture of 39.59% by mass of (pentaerythritol (tri/tetra)acrylate (PETA) (trade name: KAYARAD PET-30) manufactured by Nippon Kayaku Co., Ltd.) as a di- or higher-functional polyfunctional compound, 56.41% by mass of NATOCO UV SELF-HEALING (manufactured by Natoco Co., Ltd.) as a (meth)acrylate oligomer, 0.5% by mass of FLOWLEN AC-2300C (manufactured by Kyoeisha Chemical Co., Ltd.) as a defoamer (a compound A and a compound B), 0.5% by mass of BYK-333 (manufactured by BYK Japan KK) as a levelling agent, and 3% of Irgacure184 (manufactured by BASF) as a photopolymerization initiator was applied onto the silver mesh pattern that was the conductive portion of the film A produced above by screen printing, thereby forming a coated film. Next, the coated film was left to stand at 25° C. for 15 minutes and then exposed using a D valve manufactured by Fusion Co., Ltd. at an irradiation intensity of 160 mW/cm² so as to obtain an integrated illuminance of 1,000 mJ/cm², thereby forming a transparent insulation layer that was a 10 μm-thick cured film.

<<Measurement of Individual Physical Properties>>

<Identification of Additives>

The compositions of the compounds A and B were identified by the measurement of individual additives by nuclear magnetic resonance (NMR) and pyrolysis-GC-MS. In addition, the composition of a compound C in the transparent insulation layer was identified by extracting a polyolefin from the transparent insulation layer using a solvent such as hexane and carrying out an analysis in which pyrolysis-GC-MS was carried out. The composition of a compound D in the transparent insulation layer was identified by measuring the transparent insulation layer using a secondary ion mass spectrometry (SIMS) method.

The composition of a compound having a siloxane structure was identified by the measurement of a levelling agent by nuclear magnetic resonance (NMR). In addition, the composition of the compound having a siloxane structure in the transparent insulation layer was identified by measuring the surface of the transparent insulation layer using a secondary ion mass spectrometry (SIMS) method.

A variety of methods for identifying the compound having a siloxane structure are as described below.

Measurement of the compound having a siloxane structure by nuclear magnetic resonance (NMR): the mole number is calculated from peak intensity ratios belonging to a Si unit, an EO unit, and a PO unit in NMR.

Measurement of the compound having a siloxane structure in the transparent insulation layer using the SIMS method: Measured by standardizing the signal intensities of individual secondary ions of individual structural units as the total ion intensity (or the signal intensity of a mass peak derived from a component suitable for standardization) using a primary ion of Bi³⁺ in a TOF-SIMS device.

Measurement of the surface of the transparent insulation layer using the SIMS method: Measured by standardizing the signal intensities of individual secondary ions of a siloxane terminal structural unit, an ethylene oxide structural unit, a propylene oxide structural unit, and a dimethylsiloxane structural unit as the total ion intensity (or the signal intensity of a mass peak derived from a component suitable for standardization) using a primary ion of Bi³⁺ in a TOF-SIMS device.

<Surface Tension of Composition for Forming Transparent Insulation Layer>

A surface tension of the composition for forming a transparent insulation layer was measured at 25° C. using a contact angle instrument FTA1000 manufactured by FTA.

<Surface Energy of Transparent Insulation Layer>

A surface energy of the transparent insulation layer was measured at 25° C. using an automatic contact angle instrument DM-300 manufactured by Kyowa Interface Science, Inc.

<Total Light Transmittance>

A total light transmittance of the obtained conductive sheet for a touch sensor with respect to the visible light range (wavelength of 400 to 700 nm) was measured (meanwhile, a measurement location was a region in which the transparent insulation layer was formed). For the measurement, a spectrophotometer CM-3600A (manufactured by Konica Minolta Japan, Inc.). As a result, the total light transmittance of the conductive sheet for a touch sensor of Example 1 was 95%. In addition, in Examples 2 to 17 and Comparative Examples 1 to 5, the total light transmittances were measured in the same manner and were confirmed to be approximately 95% for all of the conductive sheets for a touch sensor.

<<Evaluation>>

A variety of evaluations were carried out on the obtained conductive sheet for a touch sensor.

<Evaluation of Levelability>

A levelability was evaluated in terms of two viewpoints of “flatness” and “the cissing resistance” by observing the to-be-exposed coated film of the composition for forming a transparent insulation layer (coating fluid) disposed on the film A in the production step of the conductive sheet for a touch sensor. Hereinafter, individual evaluation methods will be described.

(1) Flatness

According to the above-described order, a coated film was formed by applying the composition for forming a transparent insulation layer (coating fluid) to the film A and then left to stand at room temperature for 10 minutes. After the coated film was left to stand, the flatness of the coated film was visually observed and determined using the following evaluation standards. The results are shown in Table 1. Practically, the flatness is preferably determined to be “4” or higher.

“5”: Almost flat

“4”: Protrusions and recesses are slightly observed.

“3”: Clear protrusion and recesses are observed.

“2”: Large protrusion and recesses are observed.

“1”: Extremely large protrusions and recesses are observed.

(2) Evaluation of Cissing Resistance

According to the above-described order, a coated film was formed by applying the composition for forming a transparent insulation layer (coating fluid) to the film A and then left to stand at room temperature for 10 minutes. After the coated film was left to stand, the cissing resistance of the coated film was visually observed and determined using the following evaluation standards. The results are shown in Table 1. Practically, the cissing resistance is preferably determined to be “3” or higher.

“5”: There is no cissing.

“4”: There are a small number of cissing defects, but spots of film-free regions are not formed.

“3”: There are a large number of cissing defects, but spots of film-free regions are not formed.

“2”: Spots of film-free regions are partially observed.

“1”: Spots of film-free regions are observed on one surface.

<Evaluation of Film Contractility>

The film contractility of the conductive sheet for a touch sensor was evaluated by observing the to-be-exposed coated film of the composition for forming a transparent insulation layer (coating fluid) disposed on the film A in the production step of the conductive sheet for a touch sensor.

Specifically, according to the above-described order, a coated film was formed by applying the composition for forming a transparent insulation layer (coating fluid) to the film A and then left to stand at room temperature for 10 minutes. After the coated film was left to stand, the film contractility was observed visually and using a ruler and determined using the following evaluation standards. The results are shown in Table 1. Practically, the film contractility is preferably determined to be “3” or higher.

“5”: No contraction is observed.

“4”: A small protuberance is observed at an end portion, but there is no dimensional change.

“3”: A protuberance is observed at an end portion, but there is no dimensional change.

“2”: A dimensional change is observed at a part of an end portion.

“1”: A dimensional change is observed at the full surface of an end portion.

<Evaluation of Amount of Bubble Biting Immediately after Coating>

The amount of bubble biting immediately after the coating of the conductive sheet for a touch sensor was evaluated by observing the to-be-exposed coated film of the composition for forming a transparent insulation layer (coating fluid) disposed on the film A immediately after the coating in the production step of the conductive sheet for a touch sensor.

Specifically, immediately after a coated film was formed by applying the composition for forming a transparent insulation layer (coating fluid) to the film A according to the above-described order, the presence or absence of air bubbles mixed into the coated film was visually observed and determined using the following evaluation standards. The results are shown in Table 1. Practically, the amount of bubble biting is preferably determined to be “4” or higher in order to suppress the remaining of air bubble traces.

“5”: No air bubbles are observed.

“4”: An extremely small number of air bubbles are observed.

“3”: Air bubbles are somewhat partially observed.

“2”: Air bubbles are observed in a scattered manner on the entire surface.

“1”: Air bubbles are observed to cover the entire surface.

<Evaluation of Haze Value>

A haze value of the conductive sheet for a touch sensor was evaluated by attaching glass plate to one surface of a conductive sheet for a touch sensor to which the produced transparent insulation layer was attached through a transparent pressure-sensitive adhesive film 8146-3 manufactured by 3M, attaching PET to the other surface through 8146-3, and measuring the haze value using a color meter CM3600 (manufactured by Konica Minolta, Inc.).

<Evaluation of Adhesiveness>

A film for peeling (trade name “SRL-0753”, manufactured by Lintec Corporation) that was a pressure-sensitive adhesive layer-attached protective film was attached onto the transparent insulation layer in the obtained conductive sheet for a touch sensor. Specifically, the film for peeling was attached on the transparent insulation layer in the obtained conductive sheet for a touch sensor using a 2 kg roller, treated in an autoclave (40° C., 0.5 MPa) for 20 minutes, and left to stand for 24 hours. Subsequently, one end of the peeling film was gripped using an autograph manufactured by Shimadzu Corporation, and a 180-degree peel test (tensile rate: 300 mm/min) was carried out, thereby measuring the adhesive force (N/mm). The results are shown in Table 1. Practically, the adhesive force is preferably 0.12 N/25 mm or less.

### Examples 2 to 17 and Comparative Examples 1 to 5

Conductive sheets for a touch sensor of Examples 2 to 17 and Comparative Examples 1 to 5 were produced using the same method as in Example 1 except for the fact that the composition or formulation of the conductive portion material or the composition for forming the transparent insulation layer were changed as shown in Tables 1 to 4 and evaluated in the same manner. The results are shown in Tables 1 to 4.

Hereinafter, a variety of materials used in Examples 1 to 17 and Comparative Examples 1 to 5 will be described.

(Polymerizable Compound Having (Meth)Acryloyl Group)

As a polymerizable compound having a (meth)acryloyl group, compounds described below were used.

Di- or Higher-Functional Polyfunctional Compounds

“PETA”: Pentaerythritol (tri/tetra)acrylate (trade name: KAYARAD PET-30, manufactured by Nippon Kayaku Co., Ltd.)

“DPHA”: Dipentaerythritol hexaacrylate (trade name: KAYARAD DPHA, manufactured by Nippon Kayaku Co., Ltd.)

Urethane (Meth)Acrylate Compound

“NATOCO UV SELF-HEALING”: Urethane acrylate compound, manufactured by Natoco Co., Ltd.

“EXP DX-40”: Urethane acrylate compound, manufactured by DIC Corporation

“AH-300”: Urethane acrylate compound, manufactured by Kyoei Kagaku Kogyo

“UA-300H”: Urethane acrylate compound, manufactured by Kyoei Kagaku Kogyo

Monofunctional (Meth)Acrylate Monomer for Dilution

“HDDA”: 1,6-Hexanediol diacrylate, manufactured by Osaka Organic Chemical Industry Ltd.

“IBXA”: Isobomyl acrylate, manufactured by Osaka Organic Chemical Industry Ltd.

(Defoamer and Levelling Agent)

As the defoamer and the levelling agent, substances described below were used.
“FLOWLEN AC-2300C”: (manufactured by Kyoeisha Chemical Co., Ltd.)
“BYK-333”: (manufactured by BYK Japan KK)
“BYK-307”: (manufactured by BYK Japan KK)
“BYK-302”: (manufactured by BYK Japan KK)
“MEGAFACE F781F” (manufactured by DIC Corporation)
“TEGOrad2100” (manufactured by Evonik Industries)
“POLYFLOW 75”: (manufactured by Kyoeisha Chemical Co., Ltd.)

(Photopolymerization Initiator)

As the photopolymerization initiator, a photopolymerization initiator described below was used.

“Irgacurel 184”: (manufactured by BASF)

(Conductive Portion Materials)

As the conductive portion materials, materials described below were used.

“Ag mesh pattern”: A Ag mesh pattern was as described in detail in the conductive sheet for a touch sensor of Example 1.

“Cu Mesh Pattern”:

First, a 5 nm-thick Ni layer was formed on a polyethylene terephthalate (PET) film using a sputtering method, and then a 2 μm-thick Cu flat film was formed thereon by depositing copper using a vacuum deposition method in which resistance heating was carried out. Next, the same pattern as the Ag mesh pattern produced in Example 1 was provided using an ordinary lithography method, thereby producing a film having a conductive portion made of a Cu mesh pattern on a base material.

“Ag Nanowire”:

A Ag nanowire was produced according to the method described in JP2009-215594A, and a 1 μm-thick coated film was formed. Next, the same pattern as the Ag mesh pattern produced in Example 1 was provided using an ordinary photolithography method, thereby producing a film having a conductive portion made of a Ag nano wire on a base material.

TABLE 1

| | | | | Example 1 | | | Example 2 | | | Example 3 | | |
|---|---|---|---|---|---|---|---|---|---|---|---|---|
| | Material of conductive portion | | | Ag mesh pattern | | | Ag mesh pattern | | | Ag mesh pattern | | |
| Transparent | Composition for forming | Composition | Di- or higher-functional | PETA | 39.59 | wt % | PETA | 39.71 | wt % | PETA | 39.71 | wt % |
| insulation layer | transparent insulation layer | | compound | | | | | | | | | |
| | (coating fluid) | | Urethane (meth)acrylate | NATOCO | 56.41 | wt % | NATOCO | 56.59 | wt % | NATOCO | 56.59 | wt % |
| | | | compound | UV | | | UV | | | UV | | |
| | | | | SELF-HEALING | | | SELF-HEALING | | | SELF-HEALING | | |
| | | | Monofunctional | — | — | — | — | — | — | — | — | — |
| | | | (meth)acrylate monomer | | | | | | | | | |
| | | | for dilution | | | | | | | | | |
| | | | Defoamer | FLOWLEN | 0.50 | wt % | FLOWLEN | 0.35 | wt % | FLOWLEN | 0.35 | wt % |
| | | | | AC-2300C | | | AC-2300C | | | AC-2300C | | |
| | | | Levelling agent | BYK-333 | 0.50 | wt % | BYK-333 | 0.35 | wt % | BYK-333 | 0.35 | wt % |
| | | | Photopolymerization | Irgacure 184 | 3.00 | wt % | Irgacure 184 | 3.00 | wt % | Irgacure 184 | 3.00 | wt % |
| | | | initiator | | | | | | | | | |

| | | | | |
|---|---|---|---|---|
| | Surface tension of coating fluid (mN/m) | 31 | 31 | 30 |
| Composition of compound | Oligomer including at least one of isobutylene, propylene, or | Contained | Contained | Contained |
| included in transparent insulation | butene in structure (compound A) | (isobutylene + propylene or | (isobutylene + propylene or | (isobutylene + propylene or |
| layer (first embodiment) | | butene) | butene) | butene) |
| | Compound including adipic acid in structure (compound B) | Contained | Contained | Contained |
| | | (diisononyl adipate) | (diisononyl adipate) | (diisononyl adipate) |
| | Compound including siloxane structural unit | Contained | Contained | Contained |
| State of transparent insulation | Oligomer including at least one of isobutylene, propylene, or | Contained | Contained | Contained |
| layer (second embodiment) | butene in structure (compound C) | (isobutylene + propylene or | (isobutylene + propylene or | (isobutylene + propylene or |
| | | butene) | butene) | butene) |
| | Compound including adipic acid in structure (compound D) | Contained | Contained | Contained |
| | | (diisononyl adipate) | (diisononyl adipate) | (diisononyl adipate) |
| | Compound including siloxane structural unit | Contained | Contained | Contained |

| | | | |
|---|---|---|---|
| Surface energy of transparent insulation layer (mN/m) | 26 | 27 | 26 |

| | | | | | |
|---|---|---|---|---|---|
| Evaluation results | Levelability | Flatness (after 10 min) (5 (favorable) to 1 (poor)) | 5 | 4 | 4 |
| | | Cissing property (after 10 min) (5 (favorable) to 1 (poor)) | 5 | 5 | 4 |

| | | | |
|---|---|---|---|
| Film contractility (after 10 min) (5 (favorable) to 1 (poor)) | 5 | 5 | 5 |
| Bubble biting immediately after coating (after 10 min) (5 (favorable) to 1 (poor)) | 5 | 5 | 5 |
| Haze (%) | 0.14 | 0.12 | 0.17 |
| Adhesiveness between transparent insulation film and protective film (N/25 mm) | 0.09 | 0.11 | 0.1 |

| | | | | Example 4 | | | Example 5 | | | Example 6 | | |
|---|---|---|---|---|---|---|---|---|---|---|---|---|
| | Material of conductive portion | | | Ag mesh pattern | | | Ag mesh pattern | | | Ag mesh pattern | | |
| Transparent | Composition for forming | Composition | Di- or higher-functional | PETA | 39.71 | wt % | PETA | 39.71 | wt % | PETA | 39.71 | wt % |
| insulation layer | transparent insulation layer | | compound | | | | | | | | | |
| | (coating fluid) | | Urethane (meth)acrylate | NATOCO | 56.59 | wt % | NATOCO | 56.59 | wt % | NATOCO | 56.59 | wt % |
| | | | compound | UV | | | UV | | | UV | | |
| | | | | SELF-HEALING | | | SELF-HEALING | | | SELF-HEALING | | |
| | | | Monofunctional | — | — | — | — | — | — | — | — | — |
| | | | (meth)acrylate monomer | | | | | | | | | |
| | | | for dilution | | | | | | | | | |
| | | | Defoamer | FLOWLEN | 0.35 | wt % | FLOWLEN | 0.35 | wt % | FLOWLEN | 0.35 | wt % |
| | | | | AC-2300C | | | AC-2300C | | | AC-2300C | | |
| | | | Levelling agent | BYK-333 | 0.35 | wt % | BYK-333 | 0.35 | wt % | BYK-333 | 0.35 | wt % |
| | | | Photopolymerization | Irgacure 184 | 3.00 | wt % | Irgacure 184 | 3.00 | wt % | Irgacure | 3.00 | wt % |
| | | | initiator | | | | | | | 184 | | |

| | | | | |
|---|---|---|---|---|
| | Surface tension of coating fluid (mN/m) | 30 | 30 | 32 |
| Composition of compound | Oligomer including at least one of isobutylene, propylene, or | Contained | Contained | Contained |
| included in transparent insulation | butene in structure (compound A) | (isobutylene + propylene or | (isobutylene + propylene or | (isobutylene + propylene or |
| layer (first embodiment) | | butene) | butene) | butene) |
| | Compound including adipic acid in structure (compound B) | Contained | Contained | Contained |
| | | (diisononyl adipate) | (diisononyl adipate) | (diisononyl adipate) |
| | Compound including siloxane structural unit | Contained | Contained | Contained |
| State of transparent insulation | Oligomer including at least one of isobutylene, propylene, or | Contained | Contained | Contained |
| layer (second embodiment) | butene in structure (compound C) | (isobutylene + propylene or | (isobutylene + propylene or | (isobutylene + propylene or |
| | | butene) | butene) | butene) |
| | Compound including adipic acid in structure (compound D) | Contained | Contained | Contained |
| | | (diisononyl adipate) | (diisononyl adipate) | (diisononyl adipate) |
| | Compound including siloxane structural unit | Contained | Contained | Contained |

| | | | |
|---|---|---|---|
| Surface energy of transparent insulation layer (mN/m) | 29 | 31 | 30 |

| | | | | | |
|---|---|---|---|---|---|
| Evaluation results | Levelability | Flatness (after 10 min) (5 (favorable) to 1 (poor)) | 4 | 5 | 4 |
| | | Cissing property (after 10 min) (5 (favorable) to 1 (poor)) | 4 | 5 | 5 |

| | | | |
|---|---|---|---|
| Film contractility (after 10 min) (5 (favorable) to 1 (poor)) | 5 | 5 | 5 |
| Bubble biting immediately after coating (after 10 min) (5 (favorable) to 1 (poor)) | 5 | 5 | 5 |
| Haze (%) | 0.09 | 0.12 | 0.13 |
| Adhesiveness between transparent insulation film and protective film (N/25 mm) | 0.1 | 0.11 | 0.11 |

TABLE 2

| | | | | Example 7 | | | Example 8 | | | Example 9 | | |
|---|---|---|---|---|---|---|---|---|---|---|---|---|
| | Material of conductive portion | | | Ag mesh pattern | | | Ag mesh pattern | | | Ag mesh pattern | | |
| Transparent | Composition for forming | Composition | Di- or higher functional compound | PETA | 29.70 | wt % | PETA | 39.75 | wt % | PETA | 39.77 | wt % |
| insulation layer | transparent insulation layer | | Urethane (meth) acrylate compound | NATOCO | 36.90 | wt % | NATOCO | 56.65 | wt % | NATOCO | 56.68 | wt % |
| | (coating fluid) | | | UV | | | UV | | | UV | | |
| | | | | SELF-HEALING | | | SELF-HEALING | | | SELF-HEALING | | |
| | | | Monofunctional (meth)acrylate monomer | IBXA | 29.70 | wt % | — | — | — | — | — | — |
| | | | for dilution | | | | | | | | | |
| | | | Defoamer | FLOWLEN | 0.35 | wt % | FLOWLEN | 0.30 | wt % | FLOWLEN | 0.30 | wt % |
| | | | | AC-2300C | | | AC-2300C | | | AC-2300C | | |
| | | | Levelling agent | BYK-333 | 0.35 | wt % | BYK-333 | 0.30 | wt % | BYK-333 | 0.25 | wt % |
| | | | Photopolymerization initiator | Irgacure 184 | 3.00 | wt % | Irgacure 184 | 3.00 | wt % | Irgacure 184 | 3.00 | wt % |

| | | | | |
|---|---|---|---|---|
| | Surface tension of coating fluid (mN/m) | 32 | 32 | 32 |
| Composition of compound | Oligomer including at least one of isobutylene, propylene, or | Contained | Contained | Contained |
| included in transparent | butene in structure (compound A) | (isobutylene + propylene or | (isobutylene + propylene or | (isobutylene + propylene or |
| insulation layer (first | | butene) | butene) | butene) |
| embodiment) | Compound including adipic acid in structure (compound B) | Contained | Contained | Contained |
| | | (diisononyl adipate) | (diisononyl adipate) | (diisononyl adipate) |
| | Compound including siloxane structural unit | Contained | Contained | Contained |
| State of transparent insulation | Oligomer including at least one of isobutylene, propylene, or | Contained | Contained | Contained |
| layer (second embodiment) | butene in structure (compound C) | (isobutylene + propylene or | (isobutylene + propylene or | (isobutylene + propylene or |
| | | butene) | butene) | butene) |
| | Compound including adipic acid in structure (compound D) | Contained | Contained | Contained |
| | | (diisononyl adipate) | (diisononyl adipate) | (diisononyl adipate) |
| | Compound including siloxane structural unit | Contained | Contained | Contained |

| | | | |
|---|---|---|---|
| Surface energy of transparent insulation layer (mN/m) | 33 | 33 | 34 |

| | | | | | |
|---|---|---|---|---|---|
| Evaluation results | Levelability | Flatness (after 10 min) (5 (favorable) to 1 (poor)) | 4 | 4 | 4 |
| | | Cissing property (after 10 min) (5 (favorable) to 1 (poor)) | 5 | 5 | 5 |

| | Film contractility (after 10 min) (5 (favorable) to 1 (poor)) | | | 5 | | | 5 | | | 3 | | |
|---|---|---|---|---|---|---|---|---|---|---|---|---|
| | Bubble biting immediately after coating (after 10 min) (5 (favorable) to 1 (poor)) | | | 5 | | | 5 | | | 4 | | |
| | Haze (%) | | | 0.12 | | | 0.12 | | | 0.12 | | |
| | Adhesiveness between transparent insulation film and protective film (N/25 mm) | | | 0.11 | | | 0.14 | | | 0.15 | | |
| | | | | Example 10 | | | Example 11 | | | Example 12 | | |
| | Material of conductive portion | | | Ag mesh pattern | | | Ag mesh pattern | | | Ag mesh pattern | | |
| Transparent | Composition for forming | Composition | Di- or higher functional compound | PETA | 39.71 | wt % | PETA | 39.71 | wt % | PETA | 19.84 | wt % |
| insulation layer | transparent insulation layer | | Urethane (meth) acrylate compound | AH-300 | 56.59 | wt % | UA-300H | 56.59 | wt % | NATOCO | 46.71 | wt % |
| | (coating fluid) | | | | | | | | | UV | | |
| | | | | | | | | | | SELF-HEALING | | |
| | | | Monofunctional (meth)acrylate monomer | — | — | — | — | — | — | HDDA | 29.75 | wt % |
| | | | for dilution | | | | | | | | | |
| | | | Defoamer | FLOWLEN | 0.35 | wt % | FLOWLEN | 0.35 | wt % | FLOWLEN | 0.35 | wt % |
| | | | | AC-2300C | | | AC-2300C | | | AC-2300C | | |
| | | | Levelling agent | BYK-333 | 0.35 | wt % | BYK-333 | 0.35 | wt % | BYK-333 | 0.35 | wt % |
| | | | Photopolymerization initiator | Irgacure 184 | 3.00 | wt % | Irgacure 184 | 3.00 | wt % | Irgacure 184 | 3.00 | wt % |

| | | | | |
|---|---|---|---|---|
| | Surface tension of coating fluid (mN/m) | 30 | 30 | 30 |
| Composition of compound | Oligomer including at least one of isobutylene, propylene, or | Contained | Contained | Contained |
| included in transparent | butene in structure (compound A) | (isobutylene + propylene or | (isobutylene + propylene or | (isobutylene + propylene or |
| insulation layer (first | | butene) | butene) | butene) |
| embodiment) | Compound including adipic acid in structure (compound B) | Contained | Contained | Contained |
| | | (diisononyl adipate) | (diisononyl adipate) | (diisononyl adipate) |
| | Compound including siloxane structural unit | Contained | Contained | Contained |
| State of transparent insulation | Oligomer including at least one of isobutylene, propylene, or | Contained | Contained | Contained |
| layer (second embodiment) | butene in structure (compound C) | (isobutylene + propylene or | (isobutylene + propylene or | (isobutylene + propylene or |
| | | butene) | butene) | butene) |
| | Compound including adipic acid in structure (compound D) | Contained | Contained | Contained |
| | | (diisononyl adipate) | (diisononyl adipate) | (diisononyl adipate) |
| | Compound including siloxane structural unit | Contained | Contained | Contained |

| | | | |
|---|---|---|---|
| Surface energy of transparent insulation layer (mN/m) | 29 | 29 | 31 |

| | | | | | |
|---|---|---|---|---|---|
| Evaluation results | Levelability | Flatness (after 10 min) (5 (favorable) to 1 (poor)) | 4 | 4 | 4 |
| | | Cissing property (after 10 min) (5 (favorable) to 1 (poor)) | 5 | 5 | 5 |

| | | | |
|---|---|---|---|
| Film contractility (after 10 min) (5 (favorable) to 1 (poor)) | 5 | 5 | 5 |
| Bubble biting immediately after coating (after 10 min) (5 (favorable) to 1 (poor)) | 5 | 5 | 5 |
| Haze (%) | 0.12 | 0.12 | 0.12 |
| Adhesiveness between transparent insulation film and protective film (N/25 mm) | 0.11 | 0.11 | 0.11 |

TABLE 3

| | | | | Example 13 | | | Example 14 | | |
|---|---|---|---|---|---|---|---|---|---|
| | Material of conductive portion | | | Ag mesh pattern | | | Ag mesh pattern | | |
| Transparent | Composition for | Composition | Di- or higher-functional | PETA | 39.59 | wt % | PETA | 39.59 | wt % |
| insulation | forming transparent | | compound | | | | | | |
| layer | insulation layer | | Urethane (meth)acrylate | NATOCO UV | 56.41 | wt % | NATOCO UV | 56.41 | wt % |
| | (coating fluid) | | compound | SELF-HEALING | | | SELF-HEALING | | |
| | | | Monofunctional | — | — | — | — | — | — |
| | | | (meth)acrylate monomer for | | | | | | |
| | | | dilution | | | | | | |
| | | | Defoamer | FLOWLEN | 0.50 | wt % | FLOWLEN | 0.50 | wt % |
| | | | | AC-2300C | | | AC-2300C | | |
| | | | Levelling agent | BYK-307 | 0.50 | wt % | BYK-302 | 0.50 | wt % |
| | | | Photopolymerization | Irgacure 184 | 3.00 | wt % | Irgacure 184 | 3.00 | wt % |
| | | | initiator | | | | | | |
| | | Surface tension of coating fluid (mN/m) | | 30 | | | 30 | | |
| | Composition of | Oligomer including at least one of isobutylene, | | Contained | | | Contained | | |
| | compound included | propylene, or butene in structure (compound A) | | (isobutylene + | | | (isobutylene + | | |
| | in transparent | | | propylene or butene) | | | propylene or butene) | | |
| | insulation layer | Compound including adipic acid in structure | | Contained | | | Contained | | |
| | (first embodiment) | (compound B) | | (diisononyl adipate) | | | (diisononyl adipate) | | |
| | | Compound including siloxane structural unit | | Contained | | | Contained | | |
| | State of transparent | Oligomer including at least one of isobutylene, | | Contained | | | Contained | | |
| | insulation layer | propylene, or butene in structure (compound C) | | (isobutylene + | | | (isobutylene + | | |
| | (second | | | propylene or butene) | | | propylene or butene) | | |
| | embodiment) | Compound including adipic acid in structure | | Contained | | | Contained | | |
| | | (compound D) | | (diisononyl adipate) | | | (diisononyl adipate) | | |
| | | Compound including siloxane structural unit | | Contained | | | Contained | | |
| | Surface energy of transparent insulation layer (mN/m) | | | 27 | | | 27 | | |
| Evaluation results | | Levelability | Flatness (after 10 min) (5 | 5 | | | 5 | | |
| | | | (favorable) to 1 (poor)) | | | | | | |
| | | | Cissing property (after 10 min) | 5 | | | 5 | | |
| | | | (5 (favorable) to 1 | | | | | | |
| | | | (poor)) | | | | | | |
| | | Film contractility (after 10 min) (5 (favorable) | | 5 | | | 5 | | |
| | | to 1 (poor)) | | | | | | | |
| | | Bubble biting immediately after coating (after | | 5 | | | 5 | | |
| | | 10 min) (5 (favorable) to 1 (poor)) | | | | | | | |
| | | Haze (%) | | 0.12 | | | 0.16 | | |
| | | Adhesiveness between transparent insulation | | 0.08 | | | 0.11 | | |
| | | film and protective film (N/25 mm) | | | | | | | |
| | | | | Example 15 | | | Example 16 | | |
| | Material of conductive portion | | | Ag mesh pattern | | | Ag mesh pattern | | |
| Transparent | Composition for | Composition | Di- or higher-functional | PETA | 39.59 | wt % | PETA | 39.59 | wt % |
| insulation | forming transparent | | compound | | | | | | |
| layer | insulation layer | | Urethane (meth)acrylate | NATOCO UV | 56.41 | wt % | NATOCO UV | 56.41 | wt % |
| | (coating fluid) | | compound | SELF-HEALING | | | SELF-HEALING | | |
| | | | Monofunctional | — | — | — | — | — | — |
| | | | (meth)acrylate monomer for | | | | | | |
| | | | dilution | | | | | | |
| | | | Defoamer | FLOWLEN | 0.50 | wt % | FLOWLEN | 0.50 | wt % |
| | | | | AC-2300C | | | AC-2300C | | |
| | | | Levelling agent | MEGAFACE | 0.50 | wt % | TEGOrad2100 | 0.50 | wt % |
| | | | | F781F | | | | | |
| | | | Photopolymerization | Irgacure 184 | 3.00 | wt % | Irgacure 184 | 3.00 | wt % |
| | | | initiator | | | | | | |

| | Surface tension of coating fluid (mN/m) | 30 | 30 |
|---|---|---|---|
| Composition of | Oligomer including at least one of isobutylene, | Contained | Contained |
| compound included | propylene, or butene in structure (compound A) | (isobutylene + | (isobutylene + |
| in transparent | | propylene or butene) | propylene or butene) |
| insulation layer | Compound including adipic acid in structure | Contained | Contained |
| (first embodiment) | (compound B) | (diisononyl adipate) | (diisononyl adipate) |
| | Compound including siloxane structural unit | Not contained | Contained |
| State of transparent | Oligomer including at least one of isobutylene, | Contained | Contained |
| insulation layer | propylene, or butene in structure (compound C) | (isobutylene + | (isobutylene + |
| (second | | propylene or butene) | propylene or butene) |
| embodiment) | Compound including adipic acid in structure | Contained | Contained |
| | (compound D) | (diisononyl adipate) | (diisononyl adipate) |
| | Compound including siloxane structural unit | Not contained | Contained |

| | | |
|---|---|---|
| Surface energy of transparent insulation layer (mN/m) | 25 | 28 |

| | | | | |
|---|---|---|---|---|
| Evaluation results | Levelability | Flatness (after 10 min) (5 | 5 | 5 |
| | | (favorable) to 1 (poor)) | | |
| | | Cissing property (after 10 min) | 5 | 5 |
| | | (5 (favorable) to 1 | | |
| | | (poor)) | | |

| | | |
|---|---|---|
| Film contractility (after 10 min) (5 (favorable) | 5 | 3 |
| to 1 (poor)) | | |
| Bubble biting immediately after coating (after | 5 | 4 |
| 10 min) (5 (favorable) to 1 (poor)) | | |
| Haze (%) | 0.18 | 0.17 |
| Adhesiveness between transparent insulation | 0.14 | 0.11 |
| film and protective film (N/25 mm) | | |

| | | | | Example 17 | | |
|---|---|---|---|---|---|---|
| | Material of conductive portion | | | Ag mesh pattern | | |
| Transparent | Composition for | Composition | Di- or higher-functional | PETA | 39.59 | wt % |
| insulation layer | forming transparent | | compound | | | |
| | insulation layer | | Urethane (meth)acrylate | NATOCO UV | 56.41 | wt % |
| | (coating fluid) | | compound | SELF-HEALING | | |
| | | | Monofunctional | — | — | — |
| | | | (meth)acrylate monomer for | | | |
| | | | dilution | | | |
| | | | Defoamer | FLOWLEN | 0.50 | wt % |
| | | | | AC-2300C | | |
| | | | Levelling agent | POLYFLOW 75 | 0.50 | wt % |
| | | | Photopolymerization | Irgacure 184 | 3.00 | wt % |
| | | | initiator | | | |

| | Surface tension of coating fluid (mN/m) | 30 |
|---|---|---|
| Composition of | Oligomer including at least one of isobutylene, | Contained |
| compound included | propylene, or butene in structure (compound A) | (isobutylene + |
| in transparent | | propylene or butene) |
| insulation layer | Compound including adipic acid in structure | Contained |
| (first embodiment) | (compound B) | (diisononyl adipate) |
| | Compound including siloxane structural unit | Not contained |
| State of transparent | Oligomer including at least one of isobutylene, | Contained |
| insulation layer | propylene, or butene in structure (compound C) | (isobutylene + |
| (second | | propylene or butene) |
| embodiment) | Compound including adipic acid in structure | Contained |
| | (compound D) | (diisononyl adipate) |
| | Compound including siloxane structural unit | Not contained |

| | |
|---|---|
| Surface energy of transparent insulation layer (mN/m) | 29 |

| | | | |
|---|---|---|---|
| Evaluation results | Levelability | Flatness (after 10 min) (5 | 5 |
| | | (favorable) to 1 (poor)) | |
| | | Cissing property (after 10 min) | 5 |
| | | (5 (favorable) to 1 | |
| | | (poor)) | |

| | |
|---|---|
| Film contractility (after 10 min) (5 (favorable) | 4 |
| to 1 (poor)) | |
| Bubble biting immediately after coating (after | 4 |
| 10 min) (5 (favorable) to 1 (poor)) | |
| Haze (%) | 0.17 |
| Adhesiveness between transparent insulation | 0.11 |
| film and protective film (N/25 mm) | |

TABLE 4

| | | | | Comparative Example 1 | | | Comparative Example 2 | | |
|---|---|---|---|---|---|---|---|---|---|
| | Material of conductive portion | | | Ag mesh pattern | | | Ag mesh pattern | | |
| Transparent | Composition for | Composition | Di- or higher-functional | PETA | 40 | wt % | PETA | 40 | wt % |
| insulation | forming transparent | | compound | | | | | | |
| layer | insulation layer | | Urethane (meth)acrylate | NATOCO UV | 57 | wt % | NATOCO UV | 56.5 | wt % |
| | (coating fluid) | | compound | SELF-HEALING | | | SELF-HEALING | | |
| | | | Monofunctional | — | — | — | — | — | — |
| | | | (meth)acrylate monomer for | | | | | | |
| | | | dilution | | | | | | |
| | | | Defoamer | — | — | — | — | — | — |
| | | | Levelling agent | — | — | — | BYK-333 | 0.5 | wt % |
| | | | Photopolymerization initiator | Irgacure 184 | 3 | wt % | Irgacure 184 | 3 | wt % |
| | | Surface tension of coating fluid (mN/m) | | 38 | | | 31 | | |
| | Composition of | Oligomer including at least one of isobutylene, | | Not contained | | | Not contained | | |
| | compound included | propylene, or butene in structure (compound A) | | | | | | | |
| | in transparent | Compound including adipic acid in structure | | Not contained | | | Not contained | | |
| | insulation layer | (compound B) | | | | | | | |
| | (first embodiment) | Compound including siloxane structural unit | | Not contained | | | Contained | | |
| | State of transparent | Oiigomer including at least one of isobutylene, | | Not contained | | | Not contained | | |
| | insulation layer | propylene, or butene in structure (compound C) | | | | | | | |
| | (second | Compound including adipic acid in structure | | Not contained | | | Not contained | | |
| | embodiment) | (compound D) | | | | | | | |
| | | Compound including siloxane structural unit | | Not contained | | | Contained | | |
| | Surface energy of transparent insulation layer (mN/m) | | | 45 | | | 31 | | |
| Evaluation results | | Levelability | Flatness (after 10 min) (5 | 1 | | | 3 | | |
| | | | (favorable) to 1 (poor)) | | | | | | |
| | | | Cissing property (after 10 min) | 1 | | | 4 | | |
| | | | (5 (favorable) to 1 | | | | | | |
| | | | (poor)) | | | | | | |
| | | Film contractility (after 10 min) | | 1 | | | 5 | | |
| | | (5 (favorable) to 1 (poor)) | | | | | | | |
| | | Bubble biting immediately after coating | | 1 | | | 2 | | |
| | | (after 10 min) (5 (favorable) to 1 (poor)) | | | | | | | |
| | | Haze (%) | | 0.23 | | | 0.12 | | |
| | | Adhesiveness between transparent insulation | | 0.19 | | | 0.12 | | |
| | | film and protective film (N/25 mm) | | | | | | | |
| | | | | Comparative Example 3 | | | Comparative Example 4 | | |
| | Material of conductive portion | | | Ag mesh pattern | | | Ag mesh pattern | | |
| Transparent | Composition for | Composition | Di- or higher-functional | PETA | 40 | wt % | PETA | 40 | wt % |
| insulation | forming transparent | | compound | | | | | | |
| layer | insulation layer | | Urethane (meth)acrylate | NATOCO UV | 56.5 | wt % | NATOCO UV | 56 | wt % |
| | (coating fluid) | | compound | SELF-HEALING | | | SELF-HEALING | | |
| | | | Monofunctional | — | — | — | — | — | — |
| | | | (meth)acrylate monomer for | | | | | | |
| | | | dilution | | | | | | |
| | | | Defoamer | Diisononyl | 0.5 | wt % | Diisononyl | 0.5 | wt % |
| | | | | adipate | | | adipate | | |
| | | | Levelling agent | — | — | — | BYK-333 | 0.5 | wt % |
| | | | Photopolymerization initiator | Irgacure 184 | 3 | wt % | Irgacure 184 | 3 | wt % |

| | | | |
|---|---|---|---|
| | Surface tension of coating fluid (mN/m) | 36 | 31 |
| Composition of | Oligomer including at least one of isobutylene, | Not contained | Not contained |
| compound included | propylene, or butene in structure (compound A) | | |
| in transparent | Compound including adipic acid in structure | Contained | Contained |
| insulation layer | (compound B) | | |
| (first embodiment) | Compound including siloxane structural unit | Not contained | Contained |
| State of transparent | Oiigomer including at least one of isobutylene, | Not contained | Not contained |
| insulation layer | propylene, or butene in structure (compound C) | | |
| (second | Compound including adipic acid in structure | Contained | Contained |
| embodiment) | (compound D) | | |
| | Compound including siloxane structural unit | Not contained | Contained |

| | | |
|---|---|---|
| Surface energy of transparent insulation layer (mN/m) | 40 | 31 |

| | | | | |
|---|---|---|---|---|
| Evaluation results | Levelability | Flatness (after 10 min) (5 | T2 | 4 |
| | | (favorable) to 1 (poor)) | | |
| | | Cissing property (after 10 min) | 1 | 4 |
| | | (5 (favorable) to 1 | | |
| | | (poor)) | | |

| | | |
|---|---|---|
| Film contractility (after 10 min) | 2 | 5 |
| (5 (favorable) to 1 (poor)) | | |
| Bubble biting immediately after coating | 1 | 2 |
| (after 10 min) (5 (favorable) to 1 (poor)) | | |
| Haze (%) | 0.2 | 0.12 |
| Adhesiveness between transparent insulation | 0.18 | 0.12 |
| film and protective film (N/25 mm) | | |

| | | | | Comparative Example 5 | | |
|---|---|---|---|---|---|---|
| | Material of conductive portion | | | Ag mesh pattern | | |
| Transparent | Composition for | Composition | Di- or higher-functional | PETA | 40 | wt % |
| insulation layer | forming transparent | | compound | | | |
| | insulation layer | | Urethane (meth)acrylate | NATOCO UV | 56.5 | wt % |
| | (coating fluid) | | compound | SELF-HEALING | | |
| | | | Monofunctional | — | — | — |
| | | | (meth)acrylate monomer for | | | |
| | | | dilution | | | |
| | | | Defoamer | — | — | — |
| | | | Levelling agent | BYK-302 | 0.5 | wt % |
| | | | Photopolymerization initiator | Irgacure 184 | 3 | wt % |

| | | |
|---|---|---|
| | Surface tension of coating fluid (mN/m) | 29 |
| Composition of | Oligomer including at least one of isobutylene, | Not contained |
| compound included | propylene, or butene in structure (compound A) | |
| in transparent | Compound including adipic acid in structure | Not Contained |
| insulation layer | (compound B) | |
| (first embodiment) | Compound including siloxane structural unit | Contained |
| State of transparent | Oiigomer including at least one of isobutylene, | Not contained |
| insulation layer | propylene, or butene in structure (compound C) | |
| (second | Compound including adipic acid in structure | Not contained |
| embodiment) | (compound D) | |
| | Compound including siloxane structural unit | Contained |

| | |
|---|---|
| Surface energy of transparent insulation layer (mN/m) | 31 |

| | | | |
|---|---|---|---|
| Evaluation results | Levelability | Flatness (after 10 min) (5 | 3 |
| | | (favorable) to 1 (poor)) | |
| | | Cissing property (after 10 min) | 4 |
| | | (5 (favorable) to 1 | |
| | | (poor)) | |

| | |
|---|---|
| Film contractility (after 10 min) | 5 |
| (5 (favorable) to 1 (poor)) | |
| Bubble biting immediately after coating | 2 |
| (after 10 min) (5 (favorable) to 1 (poor)) | |
| Haze (%) | 0.12 |
| Adhesiveness between transparent insulation | 0.11 |
| film and protective film (N/25 mm) | |

From the results of Tables 1 to 4, it was confirmed that the transparent insulation layers of the conductive sheets for a touch sensor of the examples were excellent in terms of the levelability and were formed at the predetermined locations of the conductive portions due to the suppression of the contraction of the coated films. In addition, it was confirmed that the adhesiveness to the pressure-sensitive adhesive sheet was also favourable.

On the other hand, all of the transparent insulation layers of the conductive sheets for a touch sensor of the comparative examples were poor in terms of the levelability, and there was a place in which the coated film did not coat the predetermined location of the conductive portion due to the contraction of the coated films.

### EXPLANATION OF REFERENCES

10: conductive sheet for touch sensor
12, 22: base material
14, 34: fine metal wire
15: pressure-sensitive adhesive layer (pressure-sensitive adhesive sheet)
16: conductive portion
18, 40, 42: transparent insulation layer
20: protective substrate
24: first detection electrode
26: first drawing wire
28: second detection electrode
30: second drawing wire
32: flexible printed wiring board
36: opening portion
50: display device
100: electrostatic capacitance-type touch panel
180: electrostatic capacitance-type touch sensor

What is claimed is:

1. A conductive sheet for a touch sensor comprising:
a base material;
a pattern-like conductive portion that is disposed on the base material and is made of a fine metal wire; and
a transparent insulation layer disposed on the conductive portion,
wherein the transparent insulation layer is a layer formed using a composition for forming the transparent insulation layer including a compound A, and
the compound A is an oligomer including at least one selected from isobutylene, propylene, or butene in a structure.

2. The conductive sheet for a touch sensor according to claim 1,
wherein the composition for forming a transparent insulation layer further includes a compound B including an adipic acid structure.

3. The conductive sheet for a touch sensor according to claim 1,
wherein the composition for forming a transparent insulation layer further includes a polymerizable compound having a (meth)acryloyl group and a polymerization initiator.

4. The conductive sheet for a touch sensor according to claim 1,
wherein the composition for forming a transparent insulation layer further includes a compound including a siloxane structural unit.

5. The conductive sheet for a touch sensor according to claim 2,
wherein the composition for forming a transparent insulation layer further includes a compound including a siloxane structural unit.

6. The conductive sheet for a touch sensor according to claim 1,
wherein a surface tension of the composition for forming a transparent insulation layer is 35 mN/m or less at 25° C.

7. A conductive sheet for a touch sensor comprising:
a base material;
a pattern-like conductive portion that is disposed on the base material and is made of a fine metal wire; and
a transparent insulation layer disposed on the conductive portion,
wherein the transparent insulation layer includes a compound C, and
the compound C is an oligomer including at least one selected from isobutylene, propylene, or butene in a structure.

8. The conductive sheet for a touch sensor according to claim 7,
wherein the transparent insulation layer further includes a compound D, and the compound D includes an adipic acid structure.

9. The conductive sheet for a touch sensor according to claim 7,
wherein the transparent insulation layer further includes a (meth)acryloyl resin having a crosslinking structure.

10. The conductive sheet for a touch sensor according to claim 7,
wherein the transparent insulation layer further includes a compound including a siloxane structural unit.

11. The conductive sheet for a touch sensor according to claim 8,
wherein the transparent insulation layer further includes a compound including a siloxane structural unit.

12. The conductive sheet for a touch sensor according to claim 1,
wherein a surface energy of the transparent insulation layer is 30 mN/m or less at 25° C.

13. The conductive sheet for a touch sensor according to claim 1,
wherein the conductive portions are respectively disposed on both surfaces of the base material and have a mesh pattern made of a fine silver wire.

14. A method for manufacturing the conductive sheet for a touch sensor according to claim 1, the method comprising:
forming the transparent insulation layer on the base material and the conductive portion using a screen printing method.

15. A touch sensor comprising:
the conductive sheet for a touch sensor according to claim 1.

16. A touch panel laminate comprising in order:
the conductive sheet for a touch sensor according to claim 1;
a pressure-sensitive adhesive sheet; and
a peeling sheet.

17. A touch panel comprising:
the touch sensor according to claim 15.

18. A composition for forming a transparent insulation layer that is used to manufacture a conductive sheet for a touch sensor and is applied to a surface of a pattern-like conductive portion made of a fine metal wire,
wherein the composition for forming a transparent insulation layer includes a compound A, and
the compound A is an oligomer including at least one selected from isobutylene, propylene, or butene in a structure.

19. The composition for forming a transparent insulation layer according to claim 18,
wherein a surface tension of the composition for forming a transparent insulation layer is 35 mN/m or less at 25° C.
